(19) United States
(12) Patent Application Publication
(10) Pub. No.: US 2022/0227586 A1
(43) Pub. Date: Jul. 21, 2022

(54) Banknote-Receiving Bucket Circulating Conveying Line Apparatus, Banknote-Receiving Bucket Conveying Apparatus and Conveying Method

(71) Applicant: WEIRONG TECHNOLOGY CORPORATION, Wenzhou,Zhejiang Province (CN)

(72) Inventors: Wei WEI, Wenzhou (CN); Debei CHEN, Wenzhou (CN); Yaozhun CAI, Wenzhou (CN); Wei GUAN, Wenzhou (CN); Dayong CHENG, Wenzhou (CN); Xiaolan WEI, Wenzhou (CN); Botao NI, Wenzhou (CN)

(21) Appl. No.: 17/610,439

(22) PCT Filed: Jul. 25, 2019
(86) PCT No.: PCT/CN2019/097753

§ 371 Date: Nov. 10, 2021

(30) Foreign Application Priority Data
May 10, 2019 (CN) 201910390160.4

(51) Int. Cl. B65G 17/36; B65H 31/10; B65G 17/46; B65H 31/18; G07D 11/16

(52) U.S. Cl. CPC B65G 17/36; B65H 31/10; B65G 17/46; B65H 2701/1912; G07D 11/16; B65G 2203/0283; B65H 31/18

(57) ABSTRACT

The present invention provides a banknote-receiving bucket circulating conveying line apparatus, a banknote-receiving bucket conveying apparatus and a conveying method, wherein the banknote-receiving bucket conveying apparatus which is used to convey at least one banknote-receiving bucket comprises a conveying unit and a positioning unit, wherein the conveying unit is provided with a conveying channel such that the banknote-receiving bucket may be conveyed along the conveying channel, and the positioning unit is provided at the conveying unit such that the positioning unit may position the banknote-receiving bucket at a preset position of the conveying unit.

### BACKGROUND OF THE PRESENT INVENTION

### Field of Invention

The present invention relates to financial apparatus, and more particularly, to a banknote-receiving bucket circulating conveying line apparatus, banknote-receiving bucket conveying apparatus and conveying method.

### Description of Related Arts

In the banknote dispensing process, problems of massive banknote handling or multi-state currency boxing are involved. If manual counting and boxing are conducted, the efficiency is very low and the error rate is very high. Therefore, the utilization of mechanical operation is an inevitable choice. For example, a technical solution is disclosed in Chinese Patent Publication No. CN206711210U which mainly employs multiple banknote-receiving buckets to simultaneously receive multiple banknotes, and then outputs to complete the actions of such as boxing and cash counting. Its structure is relatively simple, and the efficiency is greatly increased in practical used.

Unfortunately, according to the problems feedback from the users, the applicant finds that the banknote-receiving bucket of the device according to CN206711210U is not accurate enough and is easy to shake during receiving, thereby causing the banknote to be scattered in the banknote-receiving bucket or spilled out of the banknote-receiving bucket. Although this risk is very low, this is an intolerable drawback as a financial apparatus.

### SUMMARY OF THE PRESENT INVENTION

In view of the above drawbacks of the current art, technical problems to be solved by the present invention include providing a banknote-receiving bucket circulating conveying line apparatus, which is capable of accurately positioning the banknote-receiving bucket and avoiding shake and wobble of the banknote-receiving bucket during banknote-receiving.

In order to achieve the above and other objectives, the present invention provides a banknote-receiving bucket circulating conveying line apparatus, which comprises at least two lifting modules and a conveying module installed between the at least two lifting modules, wherein the lifting module is adapted for driving the banknote-receiving bucket to ascend and descend, so as to input or output the banknote-receiving bucket, wherein the conveying module comprises at least one conveying line, adapted for positioning and conveying the banknote-receiving bucket, so as to allow the banknote-receiving bucket to receive banknote and convey banknote to the lifting module to be outputted along the conveying line through the lifting modules.

Preferably, the banknote-receiving bucket is mounted on a tooling plate and comprises a first buffer block and a second buffer block, respectively arranged on two parallel sides of the tooling plate, wherein the first buffer block and the second buffer block are resilient, wherein the tooling plate further has a first positioning hole, a second positioning hole. A connector is affixed on the tooling plate. The second positioning hole is aligned with a connection hole of the connector.

Preferably, the lifting module comprises an elevator frame, having a lifting sliding rail affixed thereon, wherein the lifting sliding rail is slidably assembled with a lifting sliding block and a heavy pressing sliding block;

the heavy pressing sliding block being affixed on a heavy pressing supporting plate, the heavy pressing supporting plate having a heavy pressing plate mounted thereon, the lifting sliding block being affixed on one of two lifting side plates;

the lifting side plate with the lifting sliding block mounted thereon being further assembled and affixed with an end of a lifting belt, the other end of the lifting belt bypassing a lifting wheel to be assembled and affixed with the heavy pressing supporting plate, the lifting wheel being affixed on a second lifting output shaft, the second lifting output shaft being mounted in a second lifting motor.

Preferably, the conveying module comprises at least one conveying line and a conveying frame, wherein the conveying frame comprises a conveying bottom plate, a conveying side plate and a conveying supporting plate, adapted for assembling and affixing the conveying bottom plate and the conveying side plate, so as to form the conveying frame to provide support for the conveying line.

Preferably, the conveying line comprises a jacking mechanism, a positioning mechanism, a blocking device, a conveying motor, a stroke switch, and a conveying chain;

each of the blocking device corresponding to one stroke switch, both the blocking device and the stroke switch being mounted on a support board, the support board being affixed on the conveying supporting plate or/and the conveying side plate, so as to form a pair of positioning blocking modules;

the conveying side plate having a conveying guide groove and a conveying slot arranged thereon, the conveying chain being mounted in the conveying slot;

at least two the conveying side plates being provided, one end of the two conveying side plates being rotatably assembled with a first conveying shaft respectively, the other end of the conveying side plates being rotatably assembled with a second conveying shaft respectively;

each of the first conveying shaft and the second conveying shaft comprising a first conveying chain wheel and a second conveying chain wheel, the first conveying chain wheel and the second conveying chain wheel being connected through the conveying chain to form a chain transmission mechanism;

the first conveying shaft and the conveying output shaft of the conveying motor being assembled through a coupler, the conveying chain comprising a plurality of conveying rotating wheels arranged thereon, the top of the conveying rotating wheel penetrating out of the conveying slot and entering the conveying guide groove, the conveying guide groove being adapted for being buckled and slidably assembled with the tooling plate, the conveying rotating wheels being tightly attached to the tooling plate.

Preferably, the blocking device comprises a first blocking plate, a second blocking plate, a blocking affixing block, and a blocking wheel, the first blocking plate and the second blocking plate being respectively affixed on the blocking affixing block, the blocking affixing block being assembled and affixed with the conveying side plate, a push rod motor being provided and mounted between the first blocking plate and the second blocking plate;

the telescopic shaft of the push rod motor being mounted into a blocking connection barrel with a first blocking pin penetrating the blocking connection barrel and the telescopic shaft, so as to axially assemble and affix the blocking connection barrel and the telescopic shaft;

the blocking connection barrel being arranged at an end of a blocking telescopic barrel, the blocking telescopic barrel comprising a blocking telescopic inner barrel and a blocking mounting head arranged on the other end thereof;

a second blocking pin penetrating a blocking mounting head and a blocking corner block, so as to hinge the blocking mounting head and the blocking corner block through the second blocking pin, a mounting opening groove being disposed on the blocking corner block and a torsion spring being sleeved on the portion of the second blocking pin located in the mounting opening groove, the blocking wheel being circumferentially rotatably mounted on a third blocking pin, and the third blocking pin being mounted on the blocking corner block.

Preferably, the stroke switch comprises a sensing part, wherein the sensing part is assembled with a stroke mounting block through a stroke shaft, and the stroke shaft is axially rotatable, wherein a stroke connecting plate is affixed on the stroke mounting block and a stroke rotating wheel is circumferentially rotatably mounted on the stroke connecting plate;

in the initial state, the stroke connecting plate and the sensing portion forming an included angle, when the second buffer block driving the stroke connecting plate to rotate with the stroke shaft as the center, the tooling plate being determined to reach the positioning position when the stroke connecting plate is perpendicular to the sensing part, when the stroke switch outputs a signal for the second time, the tooling plate being determined as passing, and that the tooling plate is repositioned after passing that the second signal output breaks, the tooling plate being determined as passed.

Preferably, the positioning mechanism comprises a positioning top plate, which has a first positioning protruding shaft and a second positioning protruding shaft arranged thereon, wherein the positioning top plate is affixed on a jacking beam;

after jacking the positioning top plate, the first positioning protruding shaft and the second positioning protruding shaft being respectively placed into the first positioning hole and the second positioning hole;

the second positioning hole being a blind hole, the positioning top plate having a plug, communicatively connected with a controller, the connector having a serial number information of the banknote-receiving bucket, so that after the connector is plugged and connected with the plug, the controller reads the information carried in the connector to determine whether the banknote-receiving bucket is a selected banknote-receiving bucket, and to determine that the positioning top plate and the tooling plate have completed positioning and assembling.

Preferably, the jacking mechanism comprises at least two jacking assemblies and a jacking motor, wherein the jacking assembly comprises a first jacking affixing plate, a second jacking affixing plate, and a third jacking affixing plate, wherein the first jacking affixing plate and the third jacking affixing plate are connected and affixed through a jacking connecting shaft, and the first jacking affixing plate is mounted on the conveying side plate;

the second jacking affixing plate being assembled and affixed with an end of a jacking guide shaft and the jacking beam, the other end of the jacking guide shaft penetrating the third jacking affixing plate to be assembled and affixed with a jacking limiting plate, the jacking limiting plate being prevented from passing through the third jacking affixing plate and the jacking guide shaft and the third jacking affixing plate being axially movably assembled;

the second jacking affixing plate having a jacking lug plate affixed thereon, the jacking lug plate being assembled with a bearing shaft, the bearing shaft being assembled and affixed with the inner ring of a bearing, the third jacking affixing plate having a shaft seat mounted thereon, the shaft seat being rotatably assembled with a jacking shaft, an eccentric wheel being mounted on the jacking shaft at the corresponding position to the bearing, the jacking shaft being connected with a jacking output shaft of the jacking motor through the coupler;

the eccentric wheel having a jacking groove arranged thereon, when the jacking mechanism lifts the jacking beam to the highest position, the jacking groove and the bearing being coupled and assembled.

Preferably, the third jacking affixing plate has a rotation limiting plate mounted in the vicinity of the eccentric wheel, wherein the rotation limiting plate has a rotation positioning sensor mounted thereon, implemented as a pressure sensor, wherein when the eccentric wheel rotates to be coupled and assembled with the bearing, the eccentric wheel is pressed with the rotation positioning sensor, so that the rotation positioning sensor obtains a signal input for determining that the rotation is in place, and the jacking motor stops operating,

wherein the third jacking affixing plate also has a reposition sensor mounted thereon, wherein an iron sensing block is mounted on the first jacking affixing plate at a position corresponding to the reposition sensor,

wherein when the jacking mechanism is in a non-jacking state, the reposition sensor detects constant electrical signal and the electric signal value is large, so as to determine an initial state;

wherein when the reposition sensor detects gradually weaker electrical signal, a jacking period is determined,

wherein when the reposition sensor detects a constant electrical signal and the electrical signal value is small, a jacking state is determined,

wherein when the jacking mechanism has jacked and needs to be repositioned, the jacking motor rotates reversely until the reposition sensor detects the electric signal of the initial state to stop the jacking motor from operating.

According to another aspect of the present invention, an object of the present invention is to provide a banknote-receiving bucket circulating conveying line apparatus, banknote-receiving bucket conveying apparatus and conveying method, wherein the banknote-receiving bucket circulating conveying line apparatus is capable of conducting accurate positioning of the banknote-receiving bucket.

Another objective of the present invention is to provide a banknote-receiving bucket circulating conveying line apparatus, banknote-receiving bucket conveying apparatus and conveying method, wherein the shake and wobble of the banknote-receiving bucket during the banknote receiving process can be reduced.

Another object of the present invention is to provide a banknote-receiving bucket circulating conveying line apparatus, banknote-receiving bucket conveying apparatus and conveying method, wherein the banknote-receiving bucket circulating conveying line apparatus is capable of effectively preventing the banknotes in the banknote-receiving bucket from becoming scattered or spilled out.

Another objective of the present invention is to provide a banknote-receiving bucket circulating conveying line apparatus, banknote-receiving bucket conveying apparatus and conveying method, wherein the banknote-receiving bucket circulating conveying line apparatus is capable of effectively preventing the banknotes and coins from dropping out of the banknote-receiving bucket.

Another objective of the present invention is to provide a banknote-receiving bucket circulating conveying line apparatus, banknote-receiving bucket conveying apparatus and conveying method, wherein the banknote-receiving bucket circulating conveying line apparatus is capable of conducting continuous input and output of the banknote-receiving bucket, so as to form a complete flow line.

Another objective of the present invention is to provide a banknote-receiving bucket circulating conveying line apparatus, banknote-receiving bucket conveying apparatus and conveying method, wherein the banknote-receiving bucket circulating conveying line utilizes conveying line(s) to position and convey the banknote-receiving bucket, which structure is simple and positioning is accurate.

According to an aspect of the present invention, the present invention provides a banknote-receiving bucket conveying apparatus, wherein the banknote-receiving bucket conveying apparatus is utilized for conveying at least a banknote-receiving bucket, wherein the banknote-receiving bucket conveying apparatus comprises:

a conveying unit which has a conveying channel arranged for allowing the banknote-receiving bucket to be conveyed along the conveying channel; and

a positioning unit, arranged on the conveying unit, being configured to position if the banknote-receiving bucket is at a preset position of the conveying unit.

According to the embodiments of the present invention, the banknote-receiving bucket conveying apparatus further comprises a lifting unit, which is disposed at an end of the conveying unit, allowing the banknote-receiving bucket to be automatically conveyed to the lifting unit along the conveying channel, wherein the lifting unit is configured to drive the banknote-receiving bucket to ascend and descend.

According to the embodiments of the present invention, the positioning unit comprises a blocking mechanism, which is located in the conveying channel is at least partly higher than a support board utilized in supporting the banknote-receiving bucket, so as to block the banknote-receiving bucket at a preset position.

According to the embodiments of the present invention, the banknote-receiving bucket conveying apparatus further comprises a stroke switch, which is disposed on the conveying unit and located in the conveying channel, wherein the stroke switch is configured to detect a stroke and a position of the banknote-receiving bucket.

According to the embodiments of the present invention, the positioning unit comprises a jacking mechanism and a limiting top plate, wherein the limiting top plate is liftable to be connected with the jacking mechanism, wherein when the banknote-receiving bucket is located above the limiting top plate, the limiting top plate is allowed to be lifted to be assembled with a support board for supporting the banknote-receiving bucket.

According to the embodiments of the present invention, the jacking top plate has a first positioning protrusion and a second positioning protrusion, wherein the support board has a first positioning groove and a second positioning groove, wherein when the limiting top plate is lifted to be assembled with the support board, the first positioning protrusion is coupled with the first positioning groove, and the second positioning protrusion is coupled with the second positioning groove to position the banknote-receiving bucket.

According to the embodiments of the present invention, the jacking top plate has a plug arranged thereon, wherein the support board has a connector, wherein when the jacking top plate is assembled with the support board, the plug is conducted with the connector.

According to the embodiments of the present invention, the blocking mechanism comprises a blocking motor, a blocking telescopic assembly, and a blocking member, wherein the blocking member is supported on the blocking telescopic assembly, wherein the blocking telescopic assembly is drivably connected with the blocking motor, wherein when the banknote-receiving bucket blocked by the blocking member completes banknote-receiving, the blocking motor drives the blocking telescopic assembly to retract, so that the blocking member moves downwards to be not higher than the support board, so as to allow the banknote-receiving bucket to continue to be conveyed forwards.

According to the embodiments of the present invention, the support plate has a first buffer block, which is located on a side of the support board, wherein when the support plate is blocked by the blocking mechanism, the first buffer block is located between the support board and the blocking mechanism providing cushioning effect.

According to another aspect of the present invention, the present invention provides a conveying method of a banknote-receiving bucket, comprising the steps of:

conveying the banknote-receiving bucket along a conveying channel; and

blocking the banknote-receiving bucket from a preset position by means of a blocking mechanism extending from the conveying channel.

Benefits and advantages of the present invention include:

1. The present invention is simple in structure, allowing accurately judgement of the positioning of the banknote-receiving bucket through the cooperation of the tooling plate and the jacking top plate, which positioning precision is high and is capable of effectively preventing banknotes in the banknote-receiving bucket from being scattered and preventing banknotes or coins from falling out of the banknote-receiving bucket.

2. According to the present invention, continuous input and output of the banknote-receiving bucket can be realized through the lifting module(s), so as to form a complete flow line.

3. The conveying module of the present invention is utilized for positioning and conveying the banknote-receiving box through the conveying line, which structure is simple, wherein the positioning is accurate and the position of the banknote-receiving box after positioning is relatively affixed, so as to prevent the banknotes from being scattered or dropped out of the banknote-receiving bucket.

4. The positioning mechanism of the present invention is assembled with the tooling plate through the jacking positioning plate, so that the positioning of the banknote-receiving bucket can be ensured, and the connector is insertingly connected with the plug, so that the number of the banknote-receiving bucket can be read, so as to prevent the banknote from being placed in a non-predetermined banknote-receiving bucket.

5. The blocking device of the present invention can effectively block the tooling plate, thereby realizing the positioning of the tooling plate.

6. The jacking mechanism of the present invention can test the effective jacking of the jacking beam under test, thereby ensuring the positioning precision of the tooling plate.

### BRIEF DESCRIPTION OF THE DRAWINGS

FIGS. 1-2 are perspective views of a banknote-receiving bucket circulating conveying line apparatus according to a preferred embodiment of the present invention.

FIGS. 3-10 are perspective views of a lifting module according to the preferred embodiment of the present invention, wherein FIG. 6 and FIG. 7 are the sectional views of A-A and B-B of FIG. 5 respectively, and FIGS. 8-10 are perspective view of the internal structures of the lifting module according to the preferred embodiment.

FIGS. 11-14 are perspective views of conveying module according to the preferred embodiment of the present invention, wherein FIGS. 13-14 are perspective views of part of a conveying line according to the preferred embodiment.

FIGS. 15-18 are perspective views of a blocking device according to the preferred embodiment of the present invention.

FIGS. 19-20 are perspective views of a stroke switch according to the preferred embodiment of the present invention.

FIGS. 21-25 are perspective views of a lifting machine according to the preferred embodiment of the present invention, wherein FIG. 24 is the sectional view of C-C of FIG. 23; FIG. 25 is a perspective view of a jacking assembly according to the preferred embodiment of the present invention.

FIGS. 26-28 are perspective views of a lifting mold according to the preferred embodiment of the present invention, wherein FIG. 27 is the sectional view of D-D of FIG. 26, and FIG. 28 is a perspective view of the position of a conveying chain according to the preferred embodiment of the present invention.

FIGS. 29-30 are perspective views of a banknote-receiving bucket and a jacking top plate according to the preferred embodiment of the present invention.

FIG. 31 is a perspective view of a banknote-receiving bucket conveying apparatus according to the preferred embodiment of the present invention.

FIGS. 32A and 32B are respectively perspective views in different angles of view of a banknote-receiving bucket and a support board according to the preferred embodiment of the present invention.

FIG. 33 is a perspective view of a conveying unit according to the preferred embodiment of the present invention.

FIG. 34 is a perspective view of a jacking mechanism and a limiting mechanism according to the preferred embodiment of the present invention.

FIGS. 35A and 35B are respectively perspective views in different angles of view of a blocking mechanism according to the preferred embodiment of the present invention.

FIG. 36A is a perspective view of a stroke switch according to the preferred embodiment of the present invention.

FIG. 36B is an exploded view of the stroke switch according to the preferred embodiment of the present invention.

FIGS. 37A and 37B are respectively perspective views in different angles of view of a lifting unit according to the preferred embodiment of the present invention.

FIGS. 38-43 are perspective views illustrating the banknote-receiving bucket conveying apparatus transporting a banknote-receiving bucket according to the preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

Those skilled in the art should understand that, in the disclosure of the present invention, terminologies of “longitudinal,” “lateral,” “upper,” “front,” “back,” “left,” “right,” “perpendicular,” “horizontal,” “top,” “bottom,” “inner,” “outer,” and etc. just indicate relations of direction or position are based on the relations of direction or position shown in the appended drawings, which is only to facilitate descriptions of the present invention and to simplify the descriptions, rather than to indicate or imply that the referred device or element must apply specific direction or to be operated or configured in specific direction. Therefore, the above-mentioned terminologies shall not be interpreted as confine to the present invention.

It is understandable that the term “a” should be understood as “at least one” or “one or more”. In other words, in one embodiment, the number of an element can be one and in other embodiment the number of the element can be greater than one. The term “a” is not construed as a limitation of quantity.

The present invention will be further illustrated as follows with the figures and embodiments.

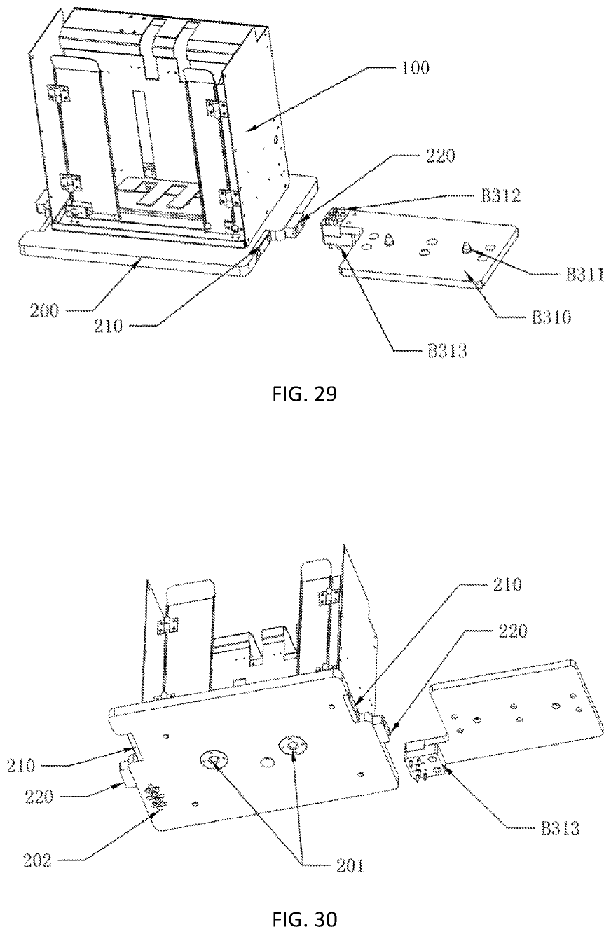

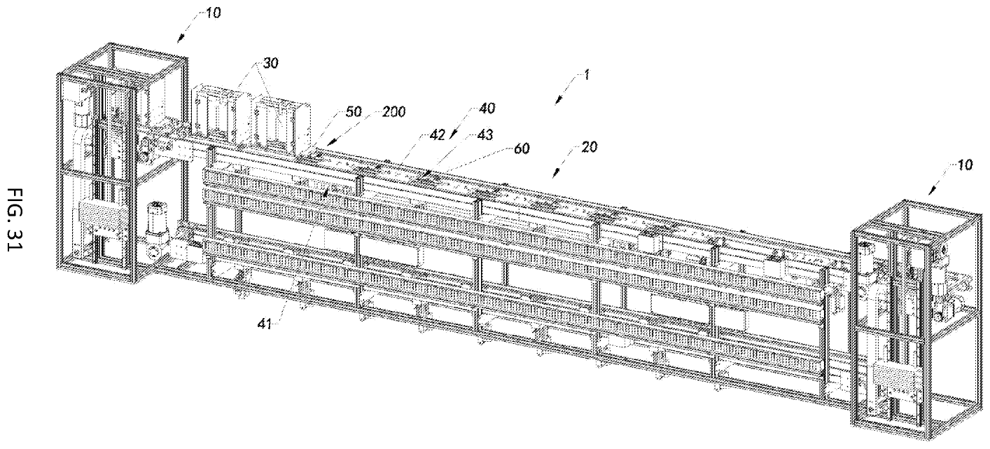

Referring to FIGS. 29-30, the banknote-receiving bucket 100 according to a preferred embodiment of the present embodiment is mounted on the tooling plate 200. The tooling plate 200 has a first buffer block 210 and a second buffer block 220 respectively mounted on two sides thereof parallel to each other. The first buffer block 210 and the second buffer block 220 are resilient so as for cushioning the impact.

According to the preferred embodiment, the first buffer block 210 and the second buffer block 220 are made of elastic rubber. The tooling plate 200 further has a first positioning hole 201 and a second positioning hole 202 arranged therein.

A connector 300 (connecting socket) is affixed on the tooling plate 200, wherein the second positioning hole 202 and a connection hole of the connector 300 are aligned (coaxial) with each other.

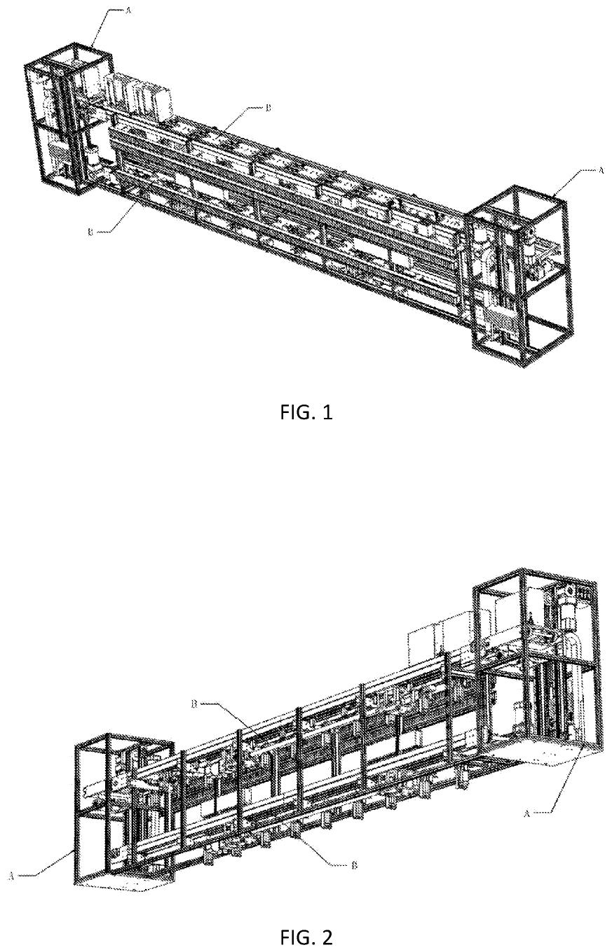

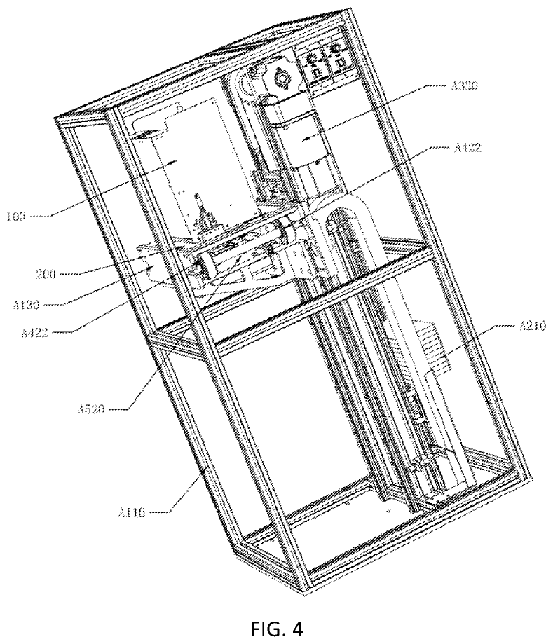

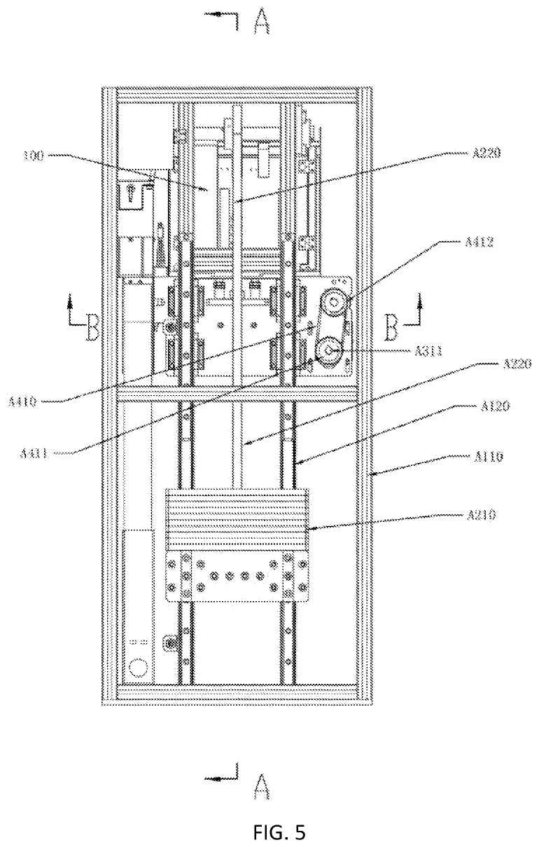

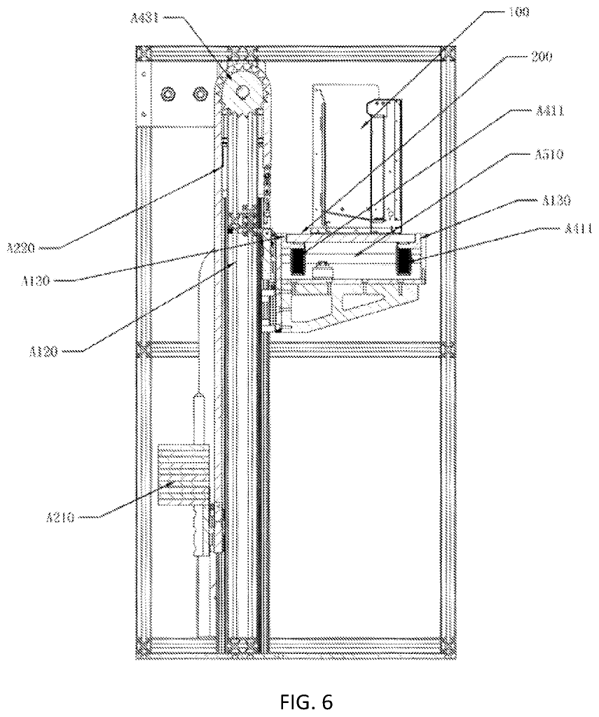

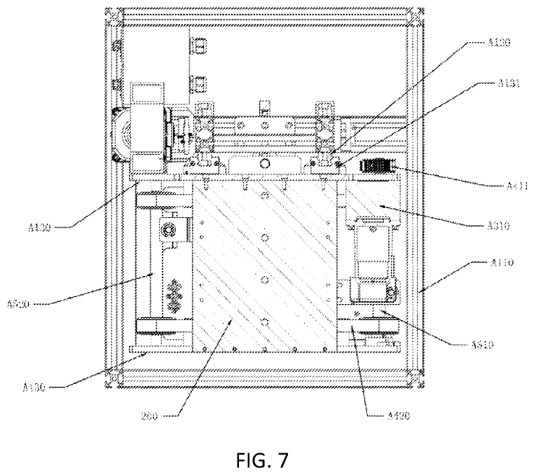

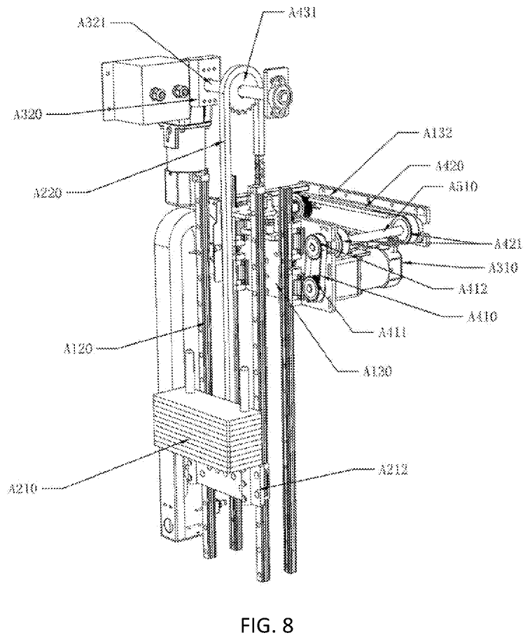

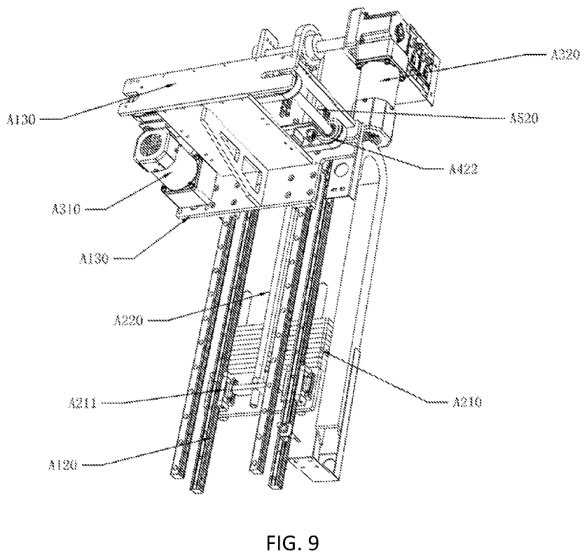

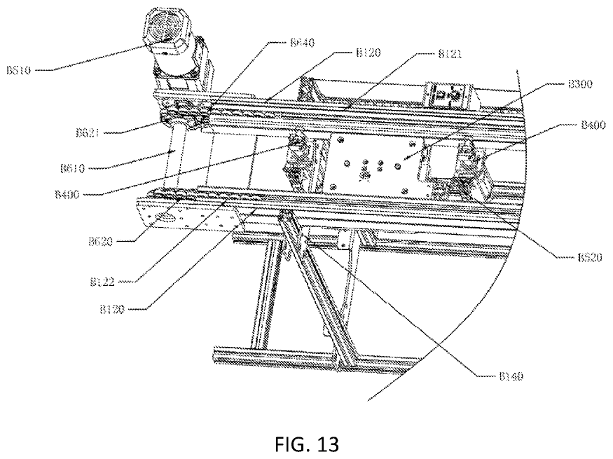

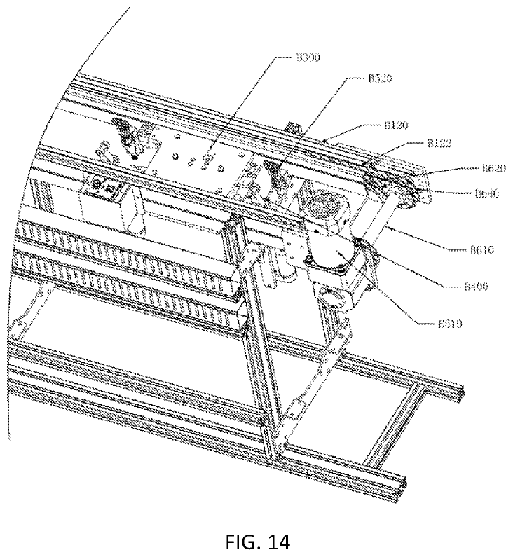

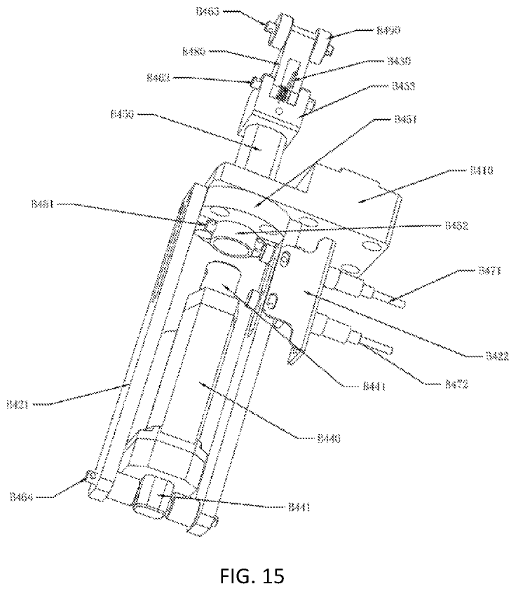

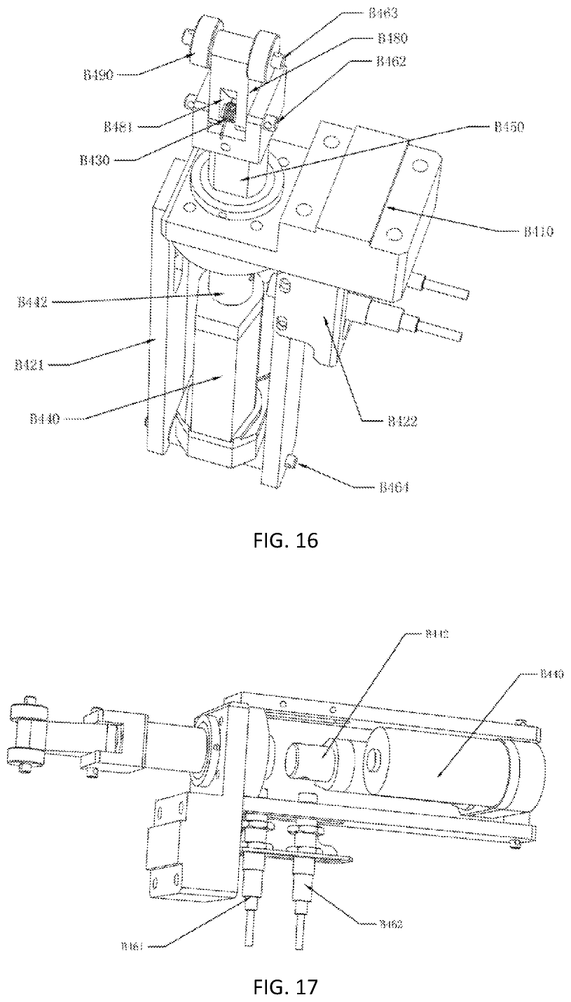

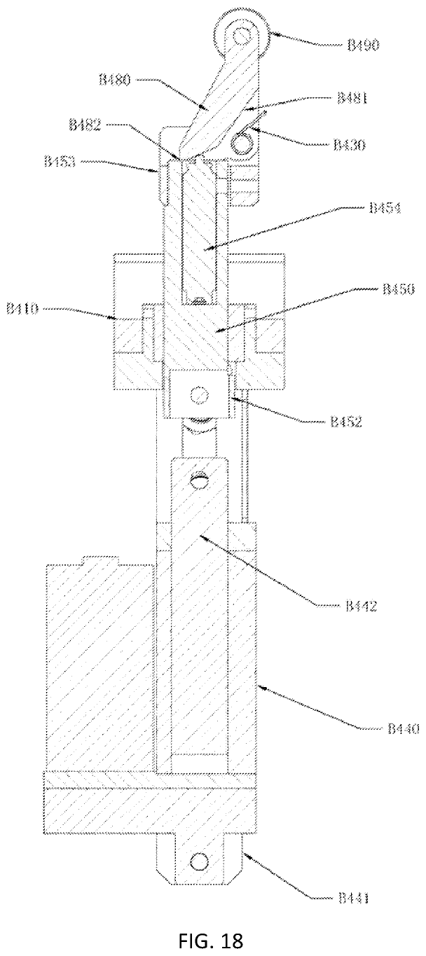

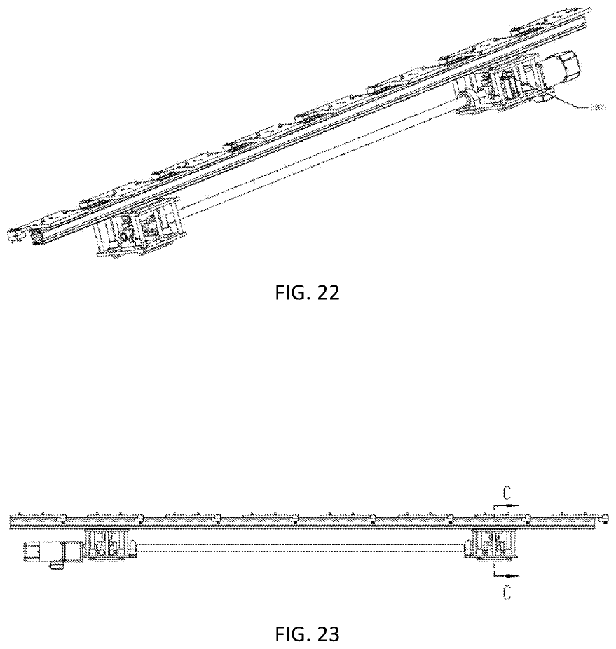

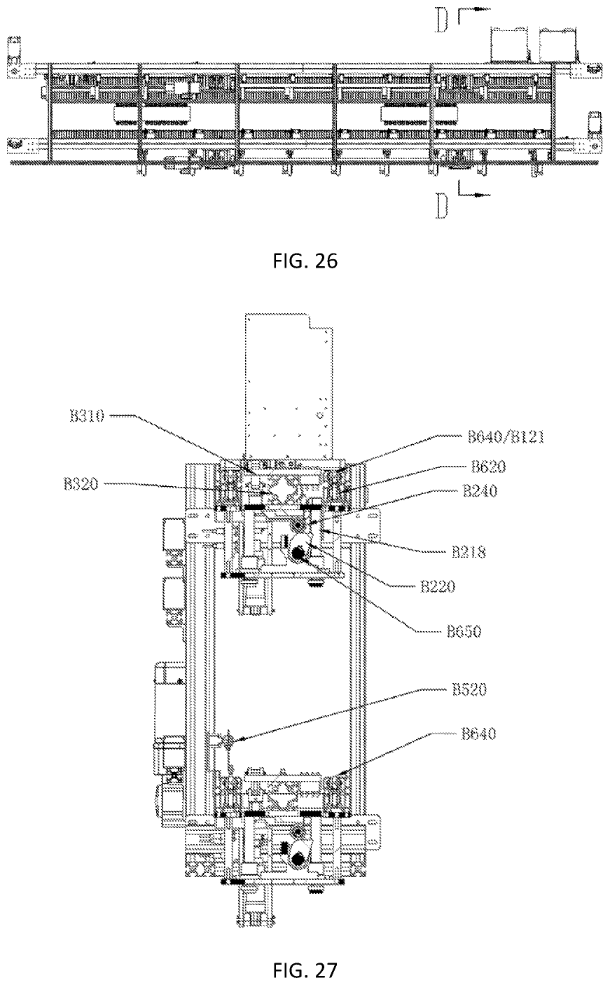

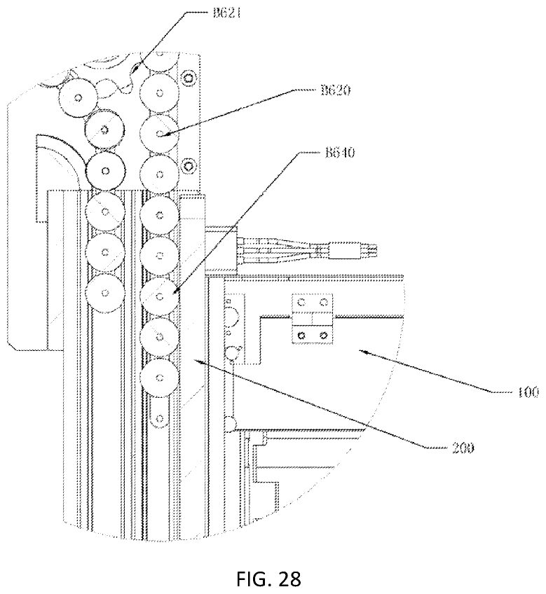

Referring to FIGS. 1-30, a banknote-receiving bucket circulating conveying line apparatus, according to the preferred embodiment, comprises at least two lifting modules A and a conveying module installed between the two lifting modules A. The lifting module A is arranged for driving the banknote-receiving bucket to ascend and descend, so as to input or output the banknote-receiving bucket 100. The conveying module comprises at least a conveying line B, arranged for positioning and conveying the banknote-receiving bucket, so as to allow the banknote-receiving bucket 100 to receive banknote and convey banknote to the lifting module A to be output along the conveying line B through the lifting modules A. In practical use, each positioning top plate positions the banknote-receiving bucket and each positioning top plate B310 is corresponding to at least one of the banknote outlet, so that the positioned banknote-receiving bucket is capable of outputting corresponding banknotes or coins from the corresponding banknote outlet.

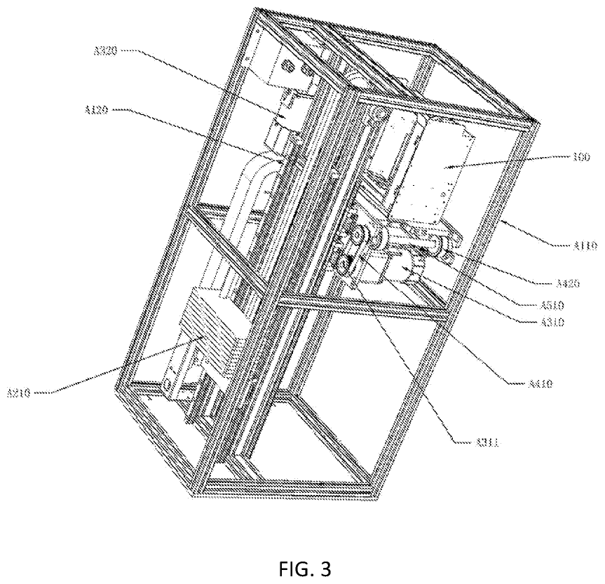

Referring to FIGS. 3-10, the lifting module A comprises an elevator frame A110 which has a lifting sliding rail A120 affixed thereon. The lifting sliding rail A120 is slidably assembled with a lifting sliding block A131 and a heavy pressing sliding block A211 respectively. The sliding directions are along the length directions of the lifting sliding rail.

The heavy pressing sliding block A211 is affixed on the heavy pressing supporting plate A212, and a heavy pressing plate A210 is mounted on the heavy pressing supporting plate A212. The lifting sliding block A131 is affixed on one of the two lifting side plates A130 and the two lifting side plates A130 are respectively rotatably assembled with the first lifting shaft A510 and the second lifting shaft A520. The two lifting side plates A130 have a lifting output sliding groove A132 respectively on the top of the end face thereof that are close to each other.

A second lifting belt pulley A421 and a second lifting sub-belt pulley A422 are affixed on the first lifting shaft A510 and on the second lifting shaft A520 respectively, wherein the second lifting belt pulley A421 and the second lifting sub-belt pulley A422 are connected through a second lifting belt A420 to form a belt transmission mechanism.

The first lifting shaft A510 further has a first lifting sub-belt pulley A412 installed thereon, wherein the first lifting sub-belt pulley A412 is connected to a first lifting belt pulley A411 through a first lifting belt A410 to form a belt transmission mechanism.

The first lifting belt pulley A411 is affixed on a first lifting output shaft A311, and the first lifting output shaft A311 is mounted in a first lifting motor A310. The first lifting motor A310 is capable of driving the first lifting output shaft A311 to rotate in the circumferential direction.

The lifting side plate A130 with the lifting sliding block A131 mounted thereon is further assembled and affixed with an end of a lifting belt A220. The other end of the lifting belt A220 bypasses a lifting wheel A431 to be assembled and affixed with the heavy pressing supporting plate A212. The lifting wheel A431 is affixed on a second lifting output shaft A321, wherein the second lifting output shaft A321 is mounted in a second lifting motor A320 so as to allow the second lifting motor A320 to drive the second lifting output shaft A321 to rotate forward and backward along the circumference direction. In this embodiment, the lifting belts are embodied as chains and the lifting wheels and pulleys are embodied as sprockets, wherein the chain and the sprocket form a chain transmission structure.

When in use, after the banknote-receiving bucket finished banknote receiving, it has to output the tooling plate 200 thereof into the lifting output sliding groove A132. When the second lifting motor A320 drives the lifting wheel A431 to rotate circumferentially, so as to drive the lifting belt A220 to move toward the lifting side plates A130, leading the lifting side plates A130 to move down along the lifting sliding rail A120 and leading the heavy pressing supporting plate A212 and the heavy pressing plate A210 move up along the lifting sliding rail. Until the lifting side plates A130 reaches a designated position, the second lifting motor will stop. At this moment, the first lifting motor will operate, so as to drive the second lifting belt A420 to rotate and the tooling plate 200 and the second lifting belt A420 are pressed, so as to allow the second lifting belt to drive the banknote-receiving bucket 100 to be output from the lifting output sliding groove in order to complete the output of the banknote-receiving bucket. After the banknote-receiving bucket is output, the second lifting motor stops running, the heavy pressing plate A210 slides down under the action of gravity, and the lifting side plate A130 rises to the position before descending under this action force.

When the banknote-receiving bucket is installed in the lifting output sliding groove and needs to rise, firstly, the tooling plate 200 is loaded into the lifting output sliding groove A132, and then the second lifting motor rotates reversely, so that the banknote-receiving bucket 100 is driven to move up and the heavy pressing plate A210 is driven to move down through the lifting belt until align with the height of the conveying line. At this moment, the first lifting motor reversely rotates to output the banknote-receiving bucket to the conveying line.

In this embodiment, the design of the heavy pressing plate A210 is mainly that one of the two lifting modules is responsible for rising the empty banknote-receiving bucket 100 to the conveying line for banknote receiving, and the other of the two lifting modules is to descend the banknote-receiving bucket that has finished banknote-receiving to the output device for outputting. Namely, one of them is only responsible for rising, while the other is only responsible for descending. During the descending, the utilization of the heavy pressing plate A210 not only achieves the automatic restoration of the lifting side plate, thereby saving energy consumption, but also allows the second lifting motor A320 to maintain power-off at this time. Here, even the empty banknote-receiving bucket 100 is to be raised, the heavy pressing plate A210 can also provide auxiliary force for the lifting belt, thereby reducing the energy consumption of the second motor. Of course, the present embodiment has two conveying lines, and therefore each lifting module A may need to perform the lifting-descending action at the same time.

Preferably, in order to position the lifting height of the lifting output sliding groove A132, so as to allow the lifting output sliding groove A132 to output a banknote-receiving bucket or input the banknote-receiving bucket, the present embodiment also designs a first lifting sensor A611 and a second lifting sensor A612, wherein a lifting sensing head A620 is mounted on the lifting side plate A130 of the lifting sliding block A131. When the lifting sensing head A620 passes the first lifting sensor A611 and the second lifting sensor A612, the first lifting sensor A611 and the second lifting sensor A612 will generate an electrical signal or the electrical signal thereof will change, so as for determining the position of the lifting sensing head A620 in order to determine the position of the lifting output sliding groove A132. In this embodiment, the lifting sensing head A620 is made of iron material, and the first lifting sensor A611 and the second lifting sensor A612 is embodied as eddy current sensor or proximity sensor.

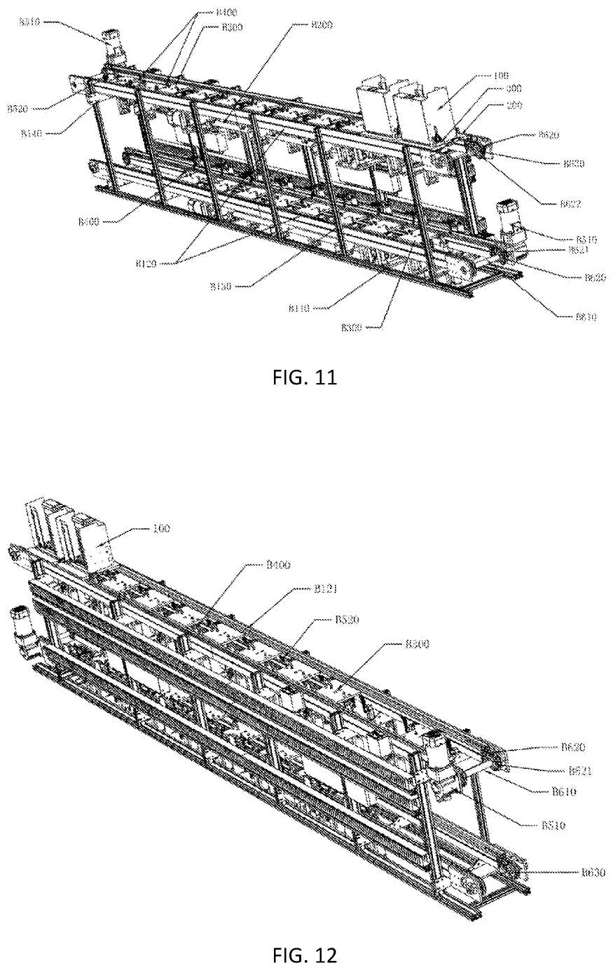

Referring to FIGS. 11-28, the conveying module comprises at least a conveying line B and a conveying frame, wherein the conveying frame comprises a conveying bottom plate B110, a conveying side plate B120, and a conveying supporting plate B130, arranged for assembling and affixing the conveying bottom plate B110 and the conveying side plate B120, so as to form the conveying frame to provide support for the conveying line B.

The conveying line B comprises a jacking mechanism B200, a positioning mechanism B300, a pair of blocking devices B400, a conveying motor B510, a stroke switch B520, and a conveying chain B620.

Each of the blocking devices B400 corresponds to a stroke switch B520, wherein the pair of blocking devices B400 and the stroke switch B520 are mounted on a support board B140, wherein the support board B140 is affixed on the conveying supporting plate B130 or/and the conveying side plate B120, so as to form a pair of positioning blocking modules. There are at least four pairs of the positioning blocking modules on each flow line according to the present embodiment, so that at least four banknote-receiving buckets can be positioned at the same time.

The conveying side plate B120 has a conveying guide groove B121 and a conveying slot B122 arranged therein, wherein the conveying chain B620 is mounted in the conveying slot B122.

At least two the conveying side plates B120 are provided, wherein one end of each of the two conveying side plates B120 is rotatably assembled with a first conveying shaft B610 respectively, while the other end of each of the conveying side plates B120 is rotatably assembled with a second conveying shaft B630 respectively.

Each of the first conveying shaft B610 and the second conveying shaft B630 comprises a first conveying chain wheel B621 and a second conveying chain wheel B622, wherein the first conveying chain wheel B621 and the second conveying chain wheel B622 are connected through the conveying chain B622 to form a chain transmission mechanism.

The first conveying shaft B610 and the conveying output shaft of the conveying motor B510 are assembled through a coupler, wherein the conveying motor B510 is capable of driving a first conveying shaft B610 to circumferentially rotate forward and backward, wherein the conveying chain B620 comprises a plurality of conveying rotating wheels B640 arranged thereon, wherein the top of the conveying rotating wheels B640 penetrates out of the conveying slot B122 and enters the conveying guide groove B121, wherein the conveying guide groove B121 is adapted for being buckled and slidably assembled with the tooling plate 200, so as for preventing deviation for the conveying on the conveying line of the tooling plate. The conveying rotating wheels B640 is attached with the tooling plate 200, so that the rotation of the conveying chain can drive the tooling plate 200 to move synchronously.

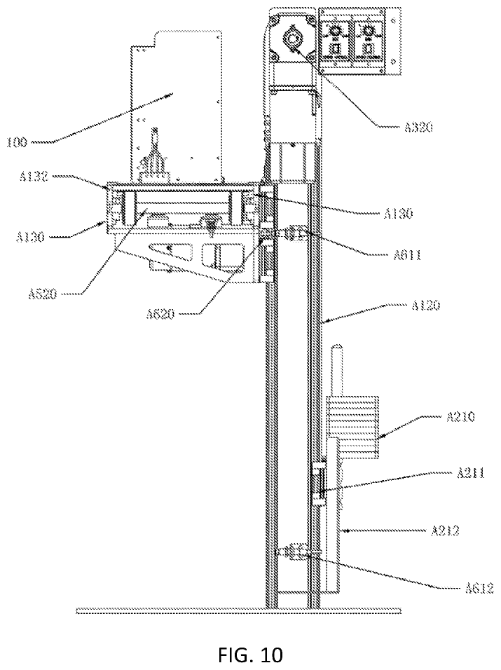

Referring to FIGS. 10-13, the blocking device B400 comprises a first blocking plate B421, a second blocking plate B422, and a blocking affixing block B410, wherein the first blocking plate B421 and the second blocking plate B422 are respectively affixed on the blocking affixing block B410. The blocking affixing block B410 is assembled and affixed with the conveying side plate B120. A push rod motor B440 is mounted between the first blocking plate B421 and the second blocking plate B422. The push rod motor B440 has a mounting protruding shaft B441 mounted on the housing thereof. A fourth blocking pin B464 passes through the first blocking plate B421, the mounting protruding shaft B441, and the second blocking plate B422, so as to affix the push rod motor B440 between the first blocking plate B421 and the second blocking plate B422.

The second blocking plate B422 has a first blocking sensor B471 and a second blocking sensor B472 arranged thereon, wherein the first blocking sensor B471 and the second blocking sensor B472 are respectively configured to detect the position of the first blocking pin B461, so as to determine the position of the blocking wheel B490.

The telescopic shaft B441 of the push rod motor B440 is mounted into a blocking connection barrel B452 with a first blocking pin B461 penetrating the blocking connection barrel B452 and the telescopic shaft B441, so as to axially assemble and affix the blocking connection barrel B452 and the telescopic shaft B441.

The blocking connection barrel B452 is arranged at an end of the blocking telescopic barrel B450, while a blocking telescopic inner barrel and a blocking mounting head are arranged on the other end of the blocking telescopic barrel B450. A buffer rod B454 is installed in the blocking telescopic inner barrel, wherein the buffer rod B454 is a hydraulic rod, which telescopic end is installed in the mounting opening groove B481 with the end face thereof being tightly attached to the inner wall of the mounting opening groove B481. This design can cushion the impact force of the blocking corner block B480 against the stop surface B482. Also, the stop surface B482 is preferably not being tightly attached to the blocking mounting head B453 in the initial state.

The blocking telescopic barrel B450 has a blocking connection barrel B452 with an end passing through the blocking affixing block B410 and being assembled and affixed with a blocking limiting ring B451, wherein the blocking limiting ring B451 cannot pass through the blocking affixing block B410 and the blocking telescopic barrel B450 is axially slidably assembled with the blocking affixing block B410.

A second blocking pin B462 penetrates a blocking mounting head B453 and a blocking corner block B480, so as to hinge the blocking mounting head B453 and the blocking corner block B480 through the second blocking pin B462, wherein a mounting opening groove B481 is disposed on the blocking corner block B480 and a torsion spring B430 is sleeved on the portion of the second blocking pin B462 located in the mounting opening groove B481. The torsion spring B430 is utilized to provide a rotation force turning the blocking corner block B480 toward the stop surface B482 or a tension hindering the blocking corner block B480 from turning away from the direction of the stop surface B482.

The first blocking pin B461 is made of iron material, and when the first blocking pin B471 respectively approaches the first blocking sensor B471 and the second blocking sensor B472, the first blocking sensor B471 and the second blocking sensor B472 generate an electrical signal change or generate an electrical signal, thereby determining the position of the first blocking pin B461. In this embodiment, the first blocking sensor B471 and the second blocking sensor B472 employ an eddy current sensor or a proximity sensor.

The blocking wheel B490 is circumferentially rotatably mounted on the third blocking pin B463, and the third blocking pin B463 is mounted on the blocking corner block B480.

The stop surface B482 is disposed on the blocking corner block B480, and the stop surface B482 is facing the horizontal direction of the torsion spring B430, which is opposite to the direction of the conveying chain conveying the tooling plate, which enables the blocking wheel B490 to hold down the tooling plate because the stop surface B482 is tightly attached to the blocking mounting head B453 when the blocking wheel B490 is tightly attached to the tooling plate 200, thereby preventing the blocking corner block B480 from rotating.

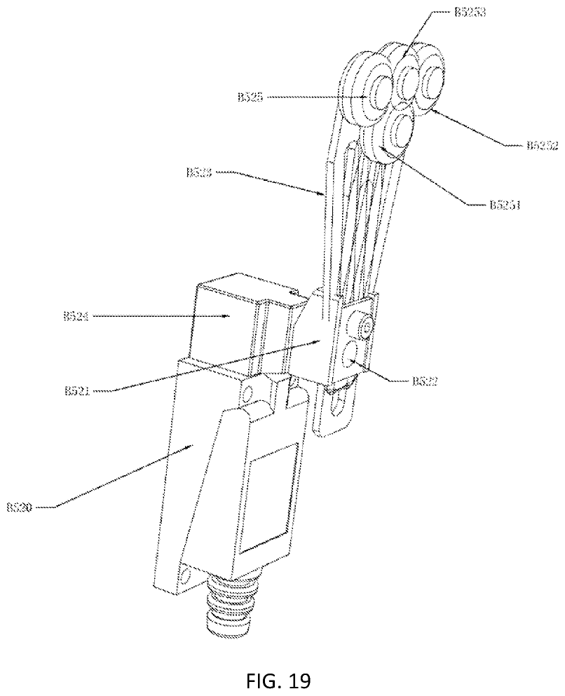

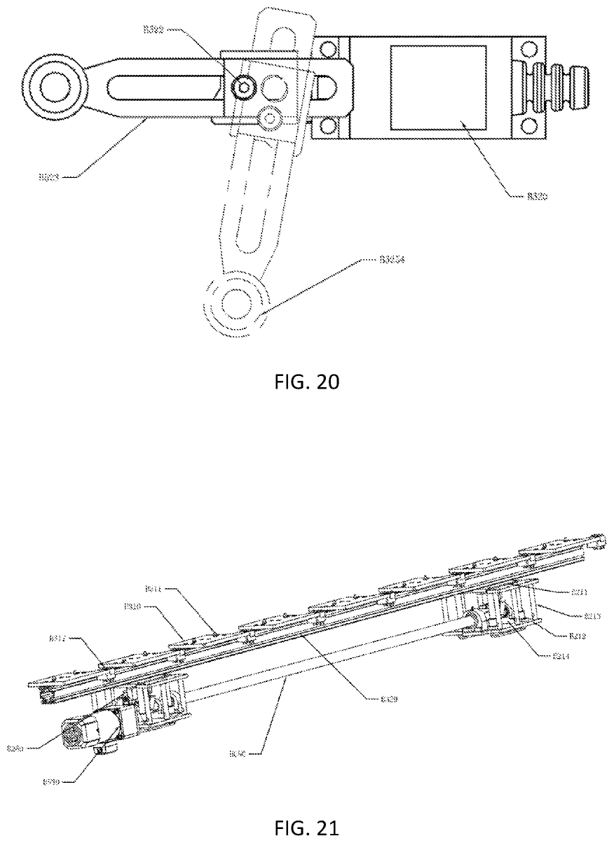

Referring to FIGS. 19-20, the stroke switch B520 includes a sensing part B524 that is assembled with the stroke mounting block B521 through a stroke shaft B522, and the stroke shaft B522 can rotate axially.

A stroke connecting plate B523 is affixed on the stroke mounting block B521, and a stroke rotating wheel B525 is rotatably mounted on the stroke connecting plate B523.

In FIGS. 19, B5251, B5252, and B5253 illustrate position changes of the stroke rotating wheel B525 during actual use.

In FIG. 20, the stroke switch is mounted on the conveying line near the bottom wall B110, and B5254 illustrates a position of the stroke rotating wheel B525 in the initial state.

When in use, the stroke connecting plate B523 is driven to drive the stroke shaft B522 to rotate, and when the stroke shaft B522 rotates to a preset angle, a built-in switch of the sensing portion B524 will be triggered, so as to determine the positional relationship between the tooling plate and the stroke switch and the motion relationship of the tooling plate. The sensing part B524 of the present embodiment may be an angle sensor that determines the state of the stroke connecting plate B523 through detecting the rotation angle of the stroke shaft B522. Of course, it is preferable to select a stroke switch since the technology is relatively mature. Here, the preferred embodiment employs the JDHK-3L model stroke switch sold by the Yueqing City Ouheng Appliance Co., Ltd.

In the initial state, the first blocking pin B461 is aligned with the first blocking sensor B471, and at this time, the top of the blocking wheel B490 exceeds the height of the conveying guide groove (the bottom surface of the tooling plate 200). Besides, the stroke switch paired with the blocking device does not receive a signal input. The stroke connecting plate B523 and the sensing part B524 form an included angle.

When the second buffer block 220 of the tooling plate is just in contact with the stroke rotating wheel B525, the blocking wheel B490 has not been in contact with the first buffer block 210. At this time, the tooling plate continues to move towards the blocking wheel B490 under the driving of the conveying chain and the second buffer block 220 drives the stroke connecting plate B523 to rotate around the stroke shaft B522 as the center until the stroke connecting plate B523 is perpendicular to the sensing part B524. At this time, the blocking wheel B490 is in contact with the first buffer block 210 and the stroke switch outputs a signal, so as to determine that the tooling plate 200 reaches the positioning position (the tooling plate reaches the positioning position above the positioning top plate B310). Then, the jacking mechanism drives the positioning top plate B310 to move upwards, so that the first positioning protruding shaft B311 and the second positioning protruding shaft B312 on the positioning top plate B310 are respectively assembled with the first positioning hole 201 and the second positioning hole 202, thereby completing the positioning of the banknote-receiving bucket, and allowing inputting banknotes into the banknote-receiving bucket.

After the banknote-receiving bucket finishes banknote-receiving, the push rod motor retracts to drive the blocking wheel B490 to move downwards through the telescopic shaft, until the first blocking pin is aligned with the second blocking sensor, wherein the blocking wheel B490 does not make contact with the tooling plate at this moment. That is, the banknote-receiving bucket can continue to move forward. The conveying chain transports the tooling plate to continue to move forward. The tool plate 200 rotates the stroke connecting plate B523 for a certain angle with the stroke shaft B522 as the center, so that the stroke switch outputs a second signal. At this time, it determines that the tooling plate is passing by. After the tooling plate has passed, the stroke switch will restore, so that the second signal output is interrupted. At this moment, it is determined that the tooling plate 200 has passed.

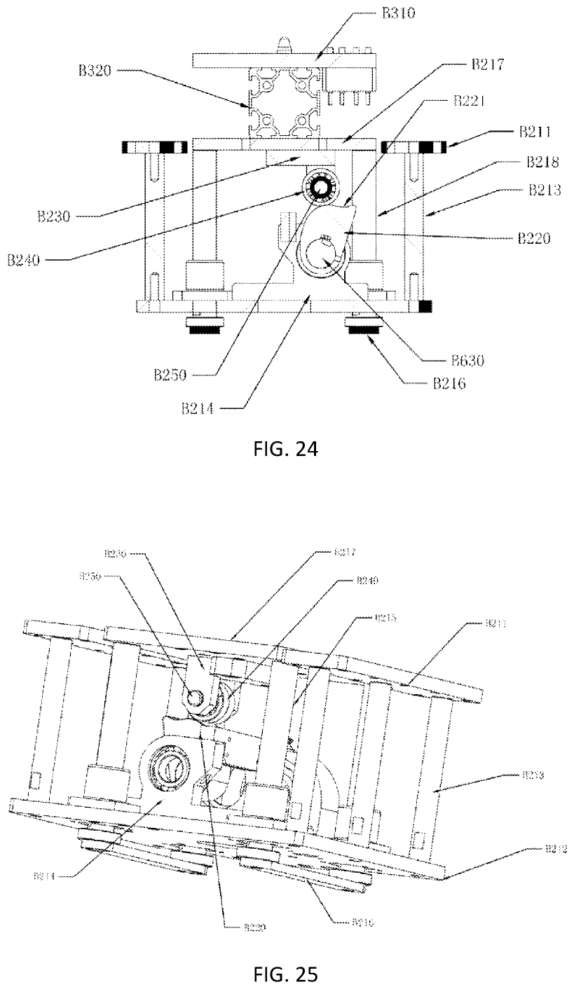

Referring to FIGS. 24, 29, and 30, the positioning mechanism B300 comprises a positioning top plate B310, which has a first positioning protruding shaft B311 and a second positioning protruding shaft B312 arranged thereon, wherein the positioning top plate B310 is affixed on a jacking beam B320. When in use, the jacking mechanism B200 jacks the positioning top plate B310 upward through lifting the jacking beam B320. As a result, the first positioning protruding shaft B311 and the second positioning protruding shaft B312 are respectively placed into the first positioning hole and the second positioning hole, Since the banknote-receiving bucket is affixed on the tooling plate 200, the tooling plate 200 is coupled and assembled with the first positioning protruding shaft B311 and the second positioning protruding shaft B 312, and is also coupled and assembled with the conveying guide groove B121, so as to prevent the banknote-receiving bucket from deviation and deflecting in the non-height direction in the non-height direction, which ensures the positioning accuracy of the banknote-receiving bucket and the position accuracy of the banknote-receiving bucket in banknote-receiving, so as to prevent banknote scatter, banknote falling, and etc. during banknote receiving.

After the banknote receiving is completed, the conveying chain conveys the banknote-receiving bucket to the output lifting module for output, and then the jacking mechanism repositions.

Preferably, the second positioning hole 202 is a blind hole, and the positioning top plate B310 has a plug B313, and the power input end of the plug B313 is electrically connected with the second positioning protruding shaft B312. When in use, the second positioning protruding shaft B312 passes through the second positioning hole 202 and then is conductively connected with the connection hole, so that the plug B313 and the connector 300 form a current loop. At this time, an electrical signal is generated, and it is determined that the positioning top plate and the tooling plate are assembled in place.

Of course, it may also be that the plug B313 is communicatively connected with the controller (CPU or MCU), and the connector 300 carries information such as the number of the banknote-receiving bucket, and after the connector 300 is plugged with the plug B313, the controller reads the information (similar to a USB disk inserted on a computer host) to determine whether it is the selected banknote-receiving bucket, and also determines that the positioning top plate and the tooling plate have completed the positioning assembly.

Referring to FIGS. 21-27, the jacking mechanism B200 comprises at least two jacking assemblies and a jacking motor B530, wherein each of the jacking assemblies comprises a first jacking affixing plate B211, a second jacking affixing plate B217, and a third jacking affixing plate B212, wherein the first jacking affixing plate B211 and the third jacking affixing plate B212 are connected and affixed through a jacking connecting shaft B213, and the first jacking affixing plate B211 is mounted on the conveying side plate B120.

The second jacking affixing plate B217 is assembled and affixed with an end of a jacking guide shaft B215 and the jacking beam B320, wherein the other end of the jacking guide shaft B215 penetrates the third jacking affixing plate B212 to be assembled and affixed with a jacking limiting plate B216, wherein the jacking limiting plate B216 is prevented from passing through the third jacking affixing plate B212, and the jacking guide shaft B215 and the third jacking affixing plate B212 are axially movably assembled.

Further, A jacking lug plate B230 is affixed on the second jacking affixing plate B217, wherein the jacking lug plate B230 is assembled with the bearing shaft B250, and the bearing shaft B250 is assembled and affixed with the inner ring of the bearing B240.

A shaft seat B214 is mounted on the third jacking affixing plate B212, wherein the shaft seat B214 is rotatably assembled with the jacking shaft B650. An eccentric wheel B220 is mounted on the bearing B240 at a position corresponding to the jacking shaft B650, wherein the eccentric wheel B220 has a jacking groove B221 arranged thereon. When the jacking mechanism jacks and lifts the jacking beam to the highest position, the jacking groove B221 and the bearing B240 are coupled and assembled, thereby providing a stable support for the bearing B240.

The third jacking affixing plate B212 has a rotation limiting plate B218 mounted in the vicinity of the eccentric wheel B220, wherein the rotation limiting plate B218 has a rotation positioning sensor mounted thereon, wherein the rotation positioning sensor may be implemented as a pressure sensor, wherein when the eccentric wheel B220 rotates to be coupled and assembled with the bearing B240, the eccentric wheel B220 is pressed with the rotation positioning sensor, so that the rotation positioning sensor obtains a signal input for determining that the rotation is in place, and the jacking motor stops operating. The jacking shaft B650 is connected with the jacking output shaft of the jacking motor B530 through a coupler and the jacking motor B530 is capable of driving the jacking shaft B650 to rotate forward and reverse in the circumferential direction.

The third jacking affixing plate B212 also has a reposition sensor B260 mounted thereon, wherein the reposition sensor B260 may be a proximity sensor or eddy current sensor, wherein an iron sensing block (not illustrated in the figures) is mounted on the first jacking affixing plate B211 at a position corresponding to the reposition sensor B260. When the jacking mechanism is in a non-jacking state (initial state), the reposition sensor B260 detects constant electrical signal and the electric signal value is large, so as to determine an initial state. When the reposition sensor B260 detects gradually weaker electrical signal, a jacking period is determined. When the reposition sensor B260 detects a constant electrical signal and the electrical signal value is small, a jacking state is determined.

When the jacking mechanism has jacked and needs to be repositioned, the jacking motor rotates reversely until the reposition sensor B260 detects the electric signal of the initial state to stop the jacking motor from operating.

The judgment in this embodiment is to convert the related electrical signal into a digital signal to be input to a controller (CPU or MCU), and then perform comparison and judgment by means of a program built in the controller.

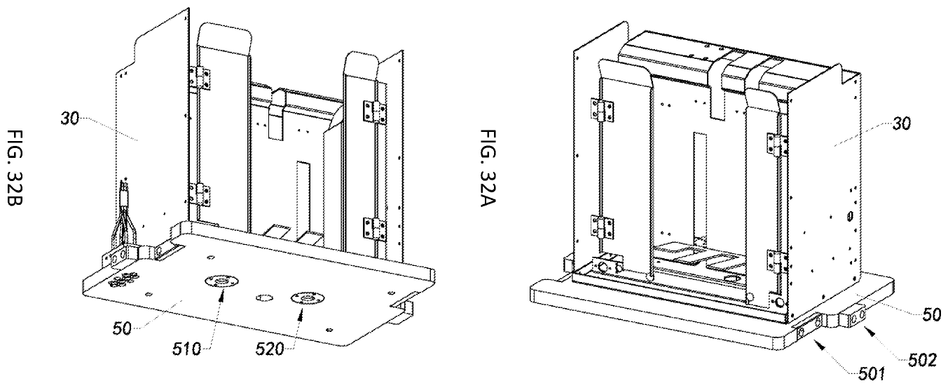

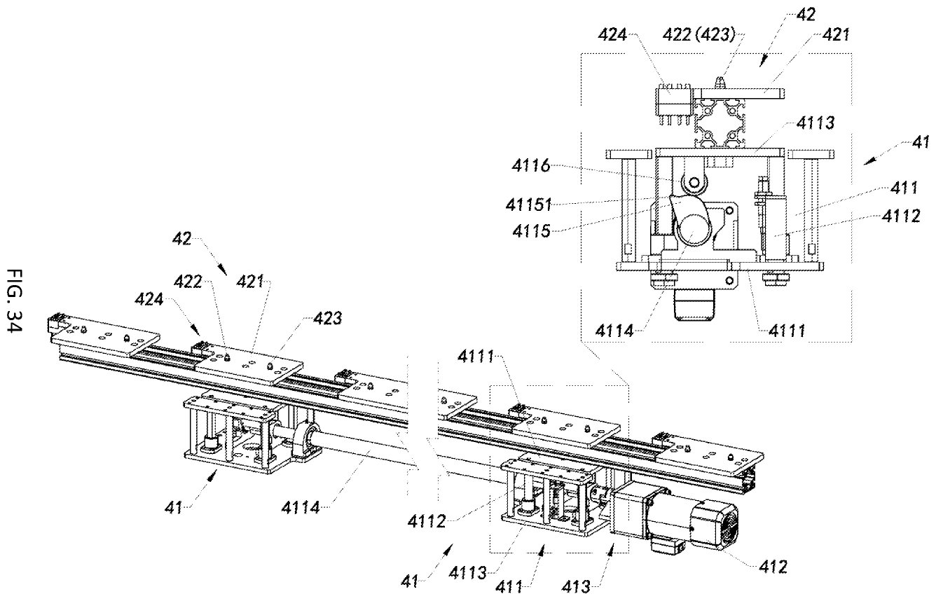

Referring to FIGS. 31-37B, a banknote-receiving bucket conveying apparatus 1 according to a preferred embodiment of the present invention is illustrated.

The banknote-receiving bucket conveying device 1 can transport banknotes or coins, and is accurate in positioning in the transportation process, so as to prevent the banknotes or coins from falling out or being lost.

Specifically, the banknote-receiving bucket conveying device 1 comprises at least one lifting unit 10 and at least one conveying unit 20, wherein when the quantity of the lifting units 10 is two, the conveying unit 20 can be located between the two lifting units 10, and the conveying unit 20 is utilized for conveying at least one banknote-receiving bucket 30, wherein the banknote-receiving bucket 30 is utilized for accommodating banknotes or coins. The banknote-receiving bucket 30 can be transported along the length direction of the conveying unit 20. After the banknote-receiving bucket 30 is transported to the conveying unit 20, the banknote-receiving bucket 30 can be positioned, and then the positioned banknote-receiving bucket 30 can be aligned to a banknote outlet. Then, corresponding banknotes and coins can be output to the banknote-receiving bucket 30 through the banknote outlet.

The lifting unit 10 is configured to drive the banknote-receiving bucket 30 to ascend and descend, so as to input or output the banknote-receiving bucket 30 in the conveying unit 20.

The banknote-receiving bucket 30 can be conveyed to a position of the lifting unit 10 on the conveying unit 20 after banknote receiving, and then be output through the lifting unit 10.

For example, one empty banknote-receiving bucket 30 may be input to the conveying unit 20 from the lifting unit 10 to receive banknotes or coins at a preset position of the conveying unit 20. After the banknote-receiving bucket 30 is filled with banknotes or coins, it is then transported to the other lifting unit 10 for outputting.

The banknote-receiving bucket circulating conveying line apparatus 1 further comprises a positioning unit 40, wherein the positioning unit 40 is disposed on the conveying unit 20 and is configured to assist in positioning the banknote-receiving bucket 30 relative to the conveying unit 20, so that the banknote-receiving bucket 30 can be aligned with the banknote outlet.

Specifically, the banknote-receiving bucket circulating conveying line apparatus 1 comprises a support board 50, wherein the banknote-receiving bucket 30 is supported on the support board 50, and the support board 50 can be transported along a conveying channel 200 of the conveying unit 20.

The positioning unit 40 comprises at least one jacking mechanism 41, at least one limiting mechanism 42 and at least one blocking mechanism 43, wherein the jacking mechanism 41, the limiting mechanism 42, and the blocking mechanism 43 are respectively arranged on the conveying unit 20, and the jacking mechanism 41 can jack up and lift the limiting mechanism 42 to limit the banknote-receiving bucket 30, and the blocking mechanism 43 is capable of blocking the banknote-receiving bucket 30, so that the banknote-receiving bucket 30 can be limited by the limiting mechanism 42 in time.

The conveying unit 20 comprises a conveying motor 21, a first conveying belt 22, and a second conveying belt 23, wherein the conveying motor 21 is capable of driving the first conveying belt 22 and the second conveying belt 23 to move, wherein the conveying channel 200 is located between the first conveying belt 22 and the second conveying belt 23.

The banknote-receiving bucket 30 is supported between the first conveying belt 22 and the second conveying belt 23 through the support board 50. The limiting mechanism 42 and the blocking mechanism 43 are respectively located between the first conveying belt 22 and the second conveying belt 23. When the banknote-receiving bucket 30 is transported normally, the limiting mechanism 42 is not higher than the first conveying belt 22 and the second conveying belt 23, so that the banknote-receiving bucket 30 can be smoothly transmitted; when the position of the banknote-receiving bucket 30 needs to be limited, the jacking mechanism 41 rises upwards to lift the limiting mechanism 42 to that at least a part of the limiting mechanism 42 is higher than the first conveying belt 22 and the second conveying belt 23, thereby limiting the position of the banknote-receiving bucket 30.

According to the preferred embodiment, the first conveying belt 22 and the second conveying belt 23 are respectively implemented as chain-type transmissions.

More specifically, the conveying unit 20 further comprises a conveying frame 24, wherein the jacking mechanism 41, the limiting mechanism 42 and the blocking mechanism 43 are respectively arranged on the conveying frame 24, wherein the first conveying belt 22 and the second conveying belt 23 are respectively arranged on the conveying frame 24.

The conveying unit 20 has a first conveying groove and a second conveying groove, wherein the first conveying groove and the second conveying groove are respectively formed on the conveying frame 24, wherein the first conveying belt 22 and the second conveying belt 23 are respectively accommodated in the first conveying groove and the second conveying groove.

The support board 50 is movably connected with the first conveying belt 22 and the second conveying belt 23 through, for example, a slidable buckling assembly manner. The support board 50 and the first conveying belt 22 and the second conveying belt 23 can move synchronously, so as to prevent the support board 50 from deviating relatively to the conveying unit 20.

The blocking mechanism 43 is capable of blocking the banknote-receiving bucket 30 through blocking the support board 50.

Specifically, at least a portion of the blocking mechanism 43 is higher than the support board 50, and the blocking mechanism 43 is located in the conveying channel 200 of the conveying unit 20. When the support board 50 supports the banknote-receiving bucket 30, and is transported to the position where the blocking mechanism 43 is located by the conveying unit 20, the protruding blocking mechanism 43 will prevent the banknote-receiving bucket 30 from continuing to move forward.

The banknote-receiving bucket circulating conveying line apparatus 1 further comprises a stroke switch 60, wherein the stroke switch 60 can cooperate with the blocking mechanism 43 to record the strokes of the banknote-receiving bucket 30.

The stroke switch 60 is disposed on the conveying unit 20 and is located in the conveying channel 200 of the conveying unit 20.

At least a portion of the blocking mechanism 43 is configured to be movable. When the banknote-receiving bucket 30 needs to be blocked, at least a portion of the blocking mechanism 43 is higher than the support board 50 to prevent the support board 50 from moving forwards. When the banknote-receiving bucket 30 needs to continue to move forward, the protruding portion of the blocking mechanism 43 can move downwards to not be higher than the support board 50, so that the support board 50 can support the banknote-receiving bucket 30 to continue to move forward.

In the process of moving the support board 50 towards the blocking mechanism 43, when the support board 50 is in contact with the blocking mechanism 43, the stroke switch 60 can output a signal, so as for determining that the support board 50 has reached the positioning position based on the signal. In other words, the support board 50 reaches the position above the limiting mechanism 42.

The jacking mechanism 41 drives at least part of the limiting mechanism 42 to ascend, so that the support board 50 is positioned at the limiting mechanism 42, thereby completing the positioning of the support board 50, thereby completing the positioning of the banknote-receiving bucket 30, so as for putting banknotes into the banknote-receiving bucket 30.

After the banknote-receiving bucket 30 finishes banknote-receiving, the blocking portion of the blocking mechanism 43 can move downward to not block the support board 50, and the support board 50 may then continue to move forward under the action of the conveying unit 20. In this process, the stroke switch 60 may detect the stroke change of the support board 50 and emit another signal representing that the support board 50 is passing by the stroke switch 60. After the support board 50 has completely passed, the stroke switch 60 may emit another signal, representing that the support board 50 has passed.

According to one embodiment of the present invention, the stroke switch 60 may be embodied as a detector, such as an infrared detector, a camera, and etc..

The stroke switch 60 is communicatively connected with the jacking mechanism 41, and the jacking mechanism 41 is capable of jacking up and lifting the limiting mechanism 42 based on the signal detected by the stroke switch 60.

According to another embodiment of the present invention, the blocking mechanism 43 may have a sensor arranged thereon, and when the support board 50 is blocked by the blocking mechanism 43, the jacking mechanism 41 communicatively connected with the blocking mechanism 43 may jack up the limiting mechanism 42.

According to another embodiment of the present invention, the banknote-receiving bucket circulating conveying line apparatus 1 comprises a detection unit, wherein the detection unit is communicatively connected with the jacking mechanism 41. The detection unit may be implemented as the stroke switch 60.

According to another embodiment of the present invention, the detection unit is communicatively connected with the lifting unit 10, the conveying unit 20, and the positioning unit 40, respectively. The lifting unit 10, the conveying unit 20, and the positioning unit 40 may operate based on the detection data of the detection unit.

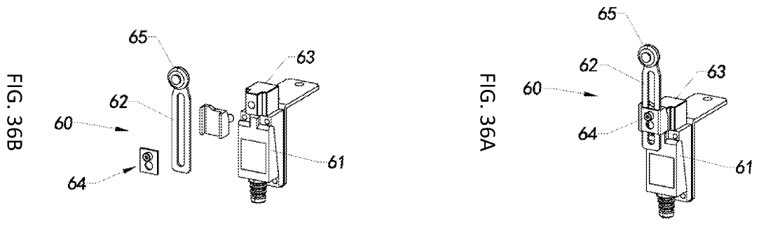

Further, according to the preferred embodiment, referring to FIGS. 35A and 35B, the blocking mechanism 43 further includes a blocking affixing block 431, a first blocking plate 432A, a second blocking plate 432B, a torsion spring 433, a push rod motor 434, a blocking telescopic assembly 435, a first blocking pin 436A, a second blocking pin 436B, a third blocking pin 436C, a first blocking sensor 437A, a second blocking sensor 437B, a blocking block 438, and a blocking member 439.

The first blocking plate 432A and the second blocking plate 432B are respectively affixed on the blocking affixing block 431 and located on a side of the blocking affixing block 431. The blocking telescopic assembly 435 can pass through the blocking affixing block 431 and a majority of the blocking telescopic assembly 435 is located on the other side of the blocking affixing block 431.

The blocking affixing block 431 is affixed on the conveying frame 24 of the conveying unit 20. The push rod motor 434 is located between the first blocking plate 432A and the second blocking plate 432B. The push rod motor 434 is capable of pushing the blocking telescopic assembly 435, so that the blocking telescopic assembly 435 can move telescopically.

The third blocking pin 436C passes through the first blocking plate 432A, the end of the push rod motor 434, and the second blocking plate 432B, such that the push rod motor 434 is mounted between the first blocking plate 432A and the second blocking plate 432B.

The push rod motor 434 has a telescopic shaft 4341, wherein the telescopic shaft 4341 has a first mounting end and a second mounting end, wherein the first mounting end of the telescopic shaft 4341 is connected with the push rod motor 434. This allows the telescopic shaft 4341 to be driven to be movably connected with the push rod motor 434 in an axial direction.

The second blocking plate 432B has a first blocking sensor 437A and a second blocking sensor 437B, wherein the first blocking sensor 437A and the second blocking sensor 437B are respectively utilized for detecting the position of the first blocking pin 436A, so as to determine the position of the blocking member 439.

The first blocking sensor 437A and the second blocking sensor 437B are arranged on the second blocking plate 432B along the length direction of the second blocking plate 432B. It should be noted that the first blocking sensor 437A and the second blocking sensor 437B are located between the second mounting end of the mounting protruding shaft 4341 and the blocking telescopic assembly 435 to detect the movement of the blocking telescopic assembly 435, thereby detecting the movement of the blocking member 439.

Specifically, the blocking telescopic assembly 435 has a high end and a low end, wherein the blocking member 439 is located at the high end of the blocking telescopic assembly 435, and the low end of the blocking telescopic assembly 435 is aligned with the position of the telescopic shaft 4341. When the position of the blocking member 439 changes, the position of the blocking telescopic assembly 435 of the blocking member 439 changes, so that the position of the low end of the blocking telescopic assembly 435 changes, which allows the first blocking sensor 437A and the second blocking sensor 437B to detect the position change of the blocking member 439 through detecting the blocking telescopic assembly 435.

The blocking member 439 may be implemented as a blocking wheel that can be in contact with the support board 50 supporting the banknote receiving bucket 30.

Further, the blocking telescopic assembly 435 comprises a blocking limiting ring 4351, a blocking connection barrel 4352, a blocking mounting head 4353, and a buffer rod 4354, wherein the blocking limiting ring 4351 is affixedly assembled on the blocking affixing block 431, and the blocking limiting ring 4351 is mounted at the low end of the blocking connection barrel 4352. In other words, the low end of the blocking connection barrel 4352 passes through the blocking affixing block 431 and is connected with the blocking limiting ring 4351. The blocking connection barrel 4352 and the blocking affixing block 431 of the blocking telescopic assembly 435 are axially slidably assembled.

The first blocking pin 436A can pass through the blocking connection barrel 4352 and the second mounting end of the telescopic shaft 4341, so that the blocking connection barrel 4352 and the telescopic shaft 4341 can be relatively assembled and affixed in the axial direction.

The blocking mounting head 4353 is mounted at the other end of the blocking connection barrel 4352, wherein the blocking mounting head 4353 and the blocking limiting ring 4351 are respectively located at two ends of the blocking connection barrel 4352.

The buffer rod 4354 is located in the blocking connection barrel 4352, and the buffer rod 4354 has a telescopic end, wherein the telescopic end of the buffer rod 4354 may be connected with the blocking block 438.

Specifically, the blocking block 438 is connected with the blocking member 439, and when the blocking member 439 blocks the support board 50, the blocking member 439 acts on the blocking block 438, and the blocking block 438 transfers the acting force to the buffer rod 4354.

The blocking mechanism 43 has a stop surface 430, wherein the stop surface 430 may be formed on the blocking block 438, wherein when the blocking member 439 blocks the support board 50, the blocking block 438 moves downward.

The second blocking pin 436B can pass through the blocking mounting head 4353 and the blocking block 438, such that the blocking mounting head 4353 and the blocking block 438 can be hinged through the second blocking pin 436B.

The blocking block 438 has a mounting opening groove 4380 arranged thereon and the torsion spring 433 is disposed on the second blocking pin 436B passing through a portion of the mounting opening groove 4380. The torsion spring 433 is utilized to generate a force that causes the blocking block 438 to turn to the stop surface 430 or generate an elastic force that prevents the blocking block 438 from rotating in a direction away from the stop surface 430.

The first blocking pin 436A may be made of iron material. When the first blocking pin 436A approaches the first blocking sensor 437A and the second blocking sensor 437B respectively, the first blocking sensor 437A and the second blocking sensor 437B generate an electrical signal change or generate an electrical signal, so as to determine the position of the first blocking pin 436A. According to this embodiment, the first blocking sensor 437A and the second blocking sensor 437B adopt an eddy current sensor.

The blocking member 439 is circumferentially rotatably mounted on the third blocking pin 436C, wherein the third blocking pin 436C is mounted on the blocking block 438. The blocking member 439 may be implemented as a blocking wheel.

The stop surface 430 is located on the blocking block 438, and the stop surface 430 faces the horizontal direction of the torsion spring 433 and the opposite direction of the conveying unit 20 conveying the support board 50, which enables the blocking member 439 to stop and hold the support board 50. Because the stop surface 430 and the blocking mounting head 4353 are tightly attached when the blocking member 439 and the support board 50 are tightly attached, the blocking block 438 is prevented from rotating, so that the support board 50 can be blocked and stopped.

Further, according to the preferred embodiment, the stroke switch 60 is mounted on the conveying frame 24 of the conveying unit 20, and is located at an inner side of the conveying frame 24. Specifically, the stroke switch 60 is located in the conveying channel 200 and is connected with the conveying frame 24. The stroke switch 60 can be detected through the support board 50 to determine the stroke and position of the support board 50.

When the support board 50 passes through the stroke switch 60, at least a portion of the stroke switch 60 is located higher than the support board 50. When the support board 50 passes, the portion of the stroke switch 60 automatically moves downward due to the action of the support board 50. When the support board 50 leaves, the stroke switch 60 is repositioned to the original position. Based on the change of the stroke switch 60 in this process, the position of the support board 50 is recorded.

The stroke switch 60 comprises a fixed component and a rotatable component, wherein the rotatable component is installed on the fixed component, and the rotatable component is rotatably connected with the fixed component around the joint of the rotatable component and the affixed component. In an initial state, the rotatable component is higher than the fixed component. The rotatable component can be in contact with the support board 50, and is capable of rotating downward due to the action of the support board 50.

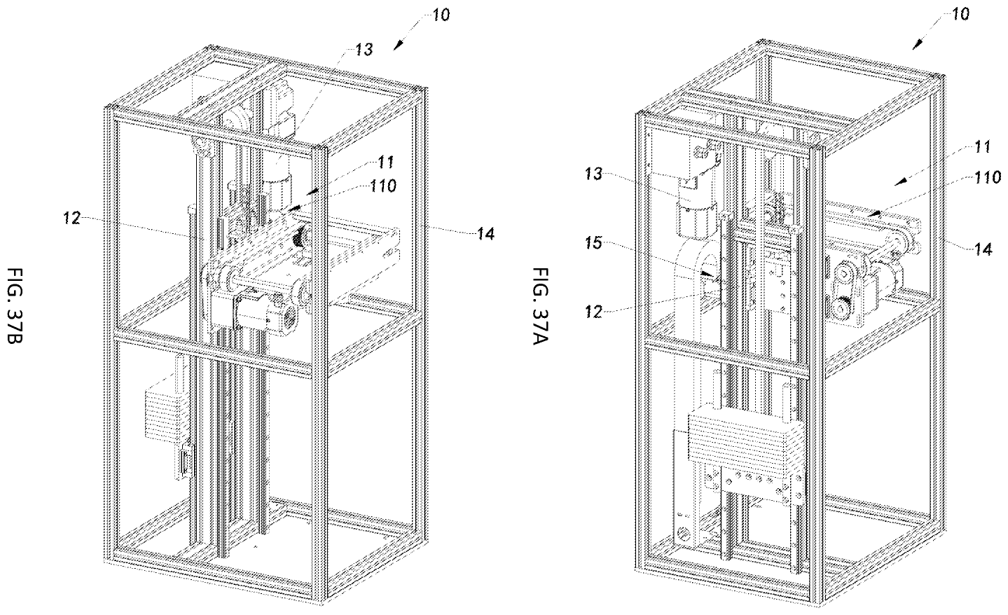

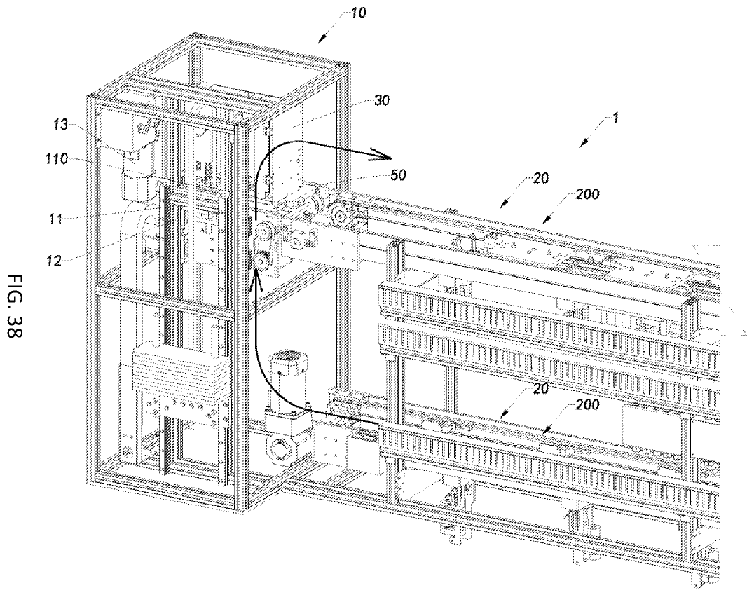

Specifically, referring to FIGS. 36A and 36B, the stroke switch 60 includes a stroke mounting portion 61, a stroke connecting portion 62, a stroke sensing portion 63, a stroke connecting shaft 64 and a stroke connecting wheel 65, wherein the stroke sensing portion 63 is mounted on the stroke mounting portion 61, wherein the stroke connecting shaft 64 is mounted on the stroke mounting portion 61, wherein the stroke sensing portion 63 is capable of sensing rotation of the stroke connecting shaft 64.

The stroke connecting portion 62 is connected with the stroke mounting portion 61 and the stroke connecting wheel 65. The stroke connecting portion 62 is rotatable about the stroke connecting shaft 64 by a certain angle, and the stroke sensing portion 63 can detect a magnitude of a rotation angle of the stroke connecting portion 62. The stroke connecting wheel 65 is mounted on the stroke connecting portion 62.

For the stroke connecting portion 62, the stroke connecting wheel 65 and the stroke mounting portion 61 are respectively connected with the stroke connecting portion 62, wherein a certain distance is provided between the stroke connecting wheel 65 and the stroke mounting portion 61. The stroke connecting portion 62 can rotate relative to the stroke mounting portion 61, and an included angle, such as an included angle of 90 degrees, may be formed between the stroke connecting portion 62 and the stroke mounting portion 61.

When in use, the stroke connecting portion 62 is driven to drive the stroke connecting shaft 64 to rotate, and when the stroke connecting shaft 64 rotates for an certain angle, the built-in detector of the stroke sensing portion 63 will be triggered, so as to determine a positional relationship between the support board 50 and the stroke switch 60 as well as a motion relationship of the support board 50.

The stroke sensing portion 63 of the stroke switch 60 may be an angle sensor, and the state of the stroke connection portion 62 is determined by detecting the rotation angle of the stroke connection shaft 64.

In the initial state, the first blocking pin 436A and the first blocking sensor 437A face each other. At this time, the top of the blocking member 439 is not lower than the height of the support board 50, and the stroke switch 60 opposite to the blocking mechanism 43 does not have signal input. The stroke connecting portion 62 and the stroke sensing portion 63 form an included angle.

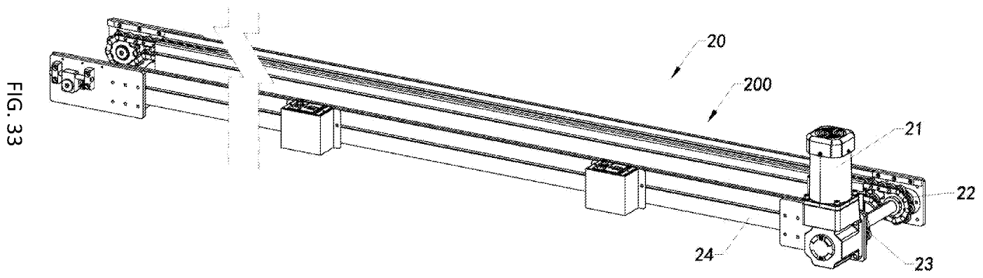

Referring to FIGS. 32A and 32B, the support board 50 has a first buffer block 501 and a second buffer block 502, wherein the first buffer block 501 and the second buffer block 502 are mounted on the side surfaces of the support board 50, for example, respectively on two parallel sides. The first buffer block 501 and the second buffer block 502 have elasticity, which is utilized to buffer a force generated by a collision. According to this embodiment, the first buffer block 501 and the second buffer block 502 are made of elastic rubber. Certainly, it shall be understood that the first buffer block 501 and the second buffer block 502 may also be supported by other buffer materials, such as a foam material, a plastic material, and etc.

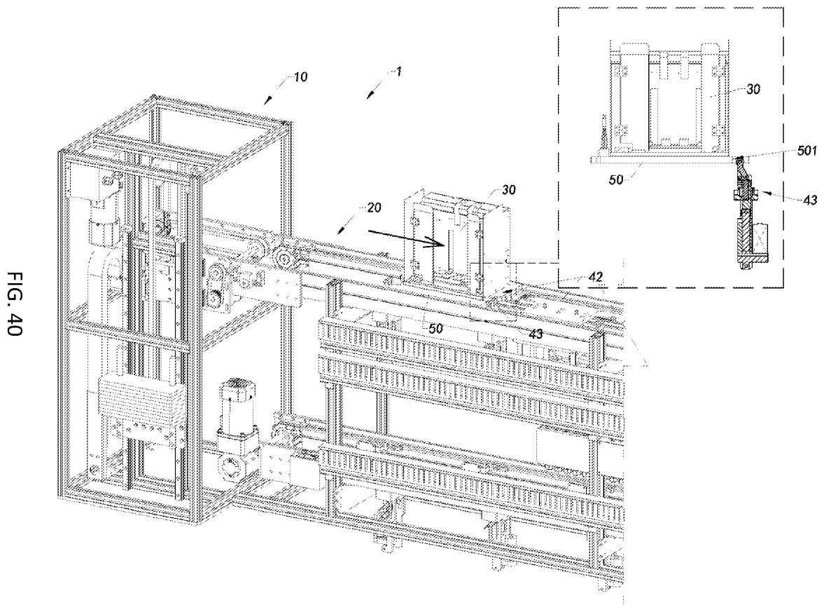

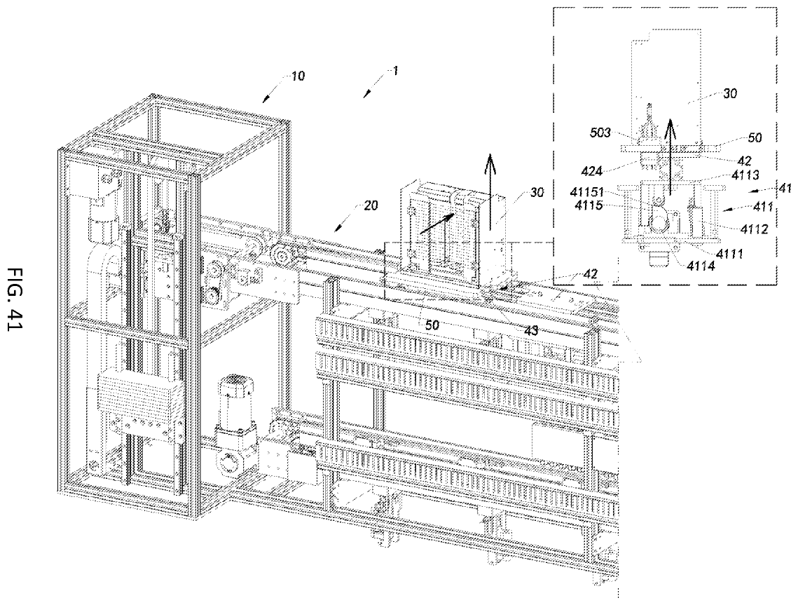

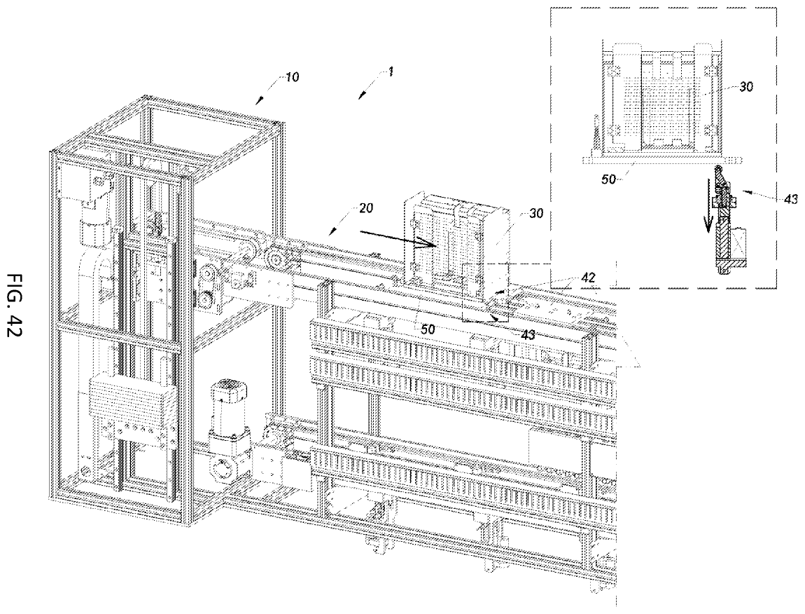

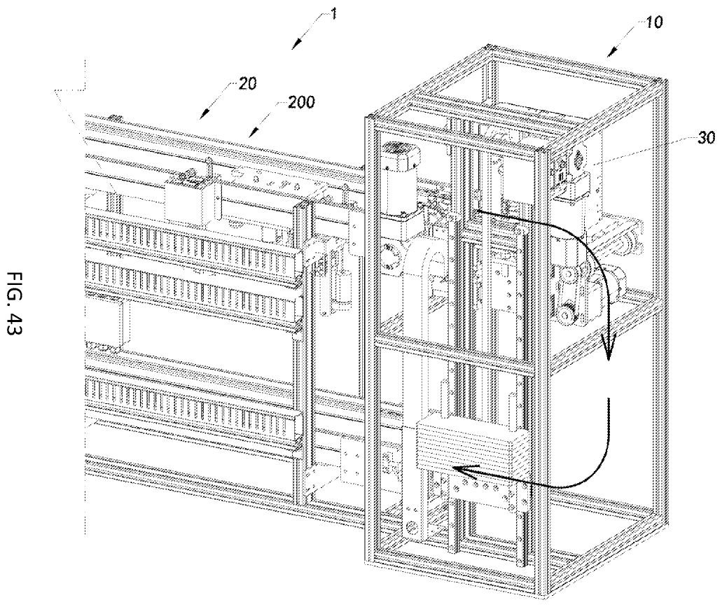

Referring to FIGS. 38-43, the working process of the banknote-receiving bucket conveying apparatus 1 according to the above preferred embodiment of the present invention is illustrated, wherein when the support board 50 approaches the blocking mechanism 43 and the stroke switch 60 and when the second buffer block 502 is in contact with the stroke connecting wheel 65 of the stroke switch 60, the blocking member 439 of the blocking mechanism 43 is temporarily not in contact with the first buffer block 501. The support board 50 continues to move forward under the action of the conveying unit 20 and moves towards the blocking mechanism 43, wherein the second buffer block 502 drives the stroke connecting portion 62 to rotate around the stroke connecting shaft 64 until the stroke connecting portion 62 and the stroke sensing portion 63 are perpendicular or reach a predetermined angle, wherein the blocking member 439 of the blocking mechanism 43 is in contact with the first buffer block 501, and at this time, the stroke switch 60 outputs a signal to determine that the support board 50 has reached the positioning position.

Then, the jacking mechanism 41 drives at least part of the limiting mechanism 42 to ascend, so as to affix the support board 50 to the limiting mechanism 42, thereby completing the limiting and positioning of the banknote-receiving bucket 30, and allowing input banknotes into the banknote-receiving bucket 30.

After the banknote-receiving bucket 30 completes the banknote receiving, the push rod motor 434 drives the blocking member 439 of the blocking mechanism 43 to move downward through driving the telescopic shaft 4341 to retract until the first blocking pin 436A and the second blocking sensor 437B are aligned. At this time, the blocking member 439 faces the support board 50 and the banknote-receiving bucket 30 can continue to move forward under the action of the conveying unit 20.

The movement of the support board 50 renders the stroke connection portion 62 of the stroke switch 60 to rotate at a certain angle around the stroke connection shaft 64 as the center, so that the stroke switch 60 outputs a second signal. At this time, it can be determined that the support board 50 is passing by, and after the support board 50 passes, the stroke switch 60 can reset and the second signal will be interrupted. At this moment, it can be determined that the support board 50 has passed.

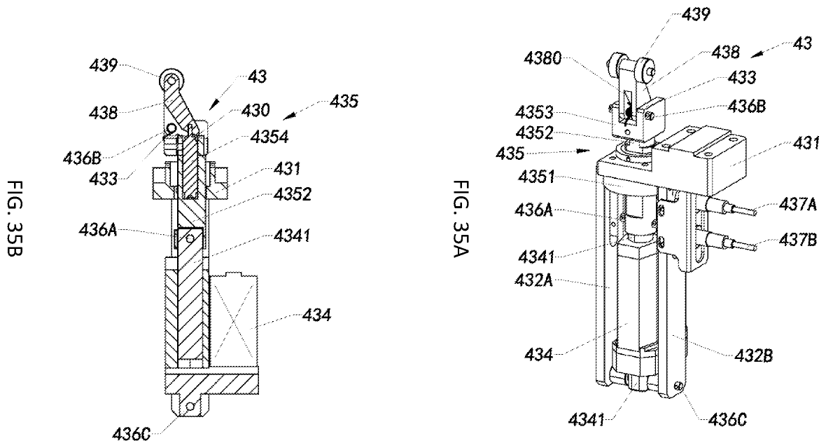

Further, according to this embodiment, referring to FIG. 34, the limiting mechanism 42 includes a limiting top plate 421, a first positioning protrusion 422, and a second positioning protrusion 423, wherein the first positioning protrusion 422 and the second positioning protrusion 423 are respectively disposed on the limiting top plate 421.

Correspondingly, also referring to FIG. 32B, the support board 50 has a first positioning groove 510 and a second positioning groove 520, wherein when the limiting top plate 421 is lifted from bottom to top towards the support board 50, the first positioning protrusion 422 and the second positioning protrusion 423 may enter the first positioning groove 510 and the second positioning groove 520 of the support board 50 respectively, so as to limit and position the support board 50 on the limiting top plate 421.

It should be noted that, according to some other embodiments of the present invention, the first positioning groove 510 and the second positioning groove 520 may be provided on the limiting top plate 421, and the first positioning protrusion 422 and the second positioning protrusion 423 may be provided on the support board 50. According to another embodiment of the present invention, the first positioning groove 510 and the second positioning protrusion 423 may be located on the limiting top plate 421, wherein the first positioning protrusion 422 and the second positioning groove 520 may be provided on the support board 50.

The support board 50 and the limiting mechanism 42 may be buckled and assembled with each other, so as to prevent the banknote-receiving bucket 30 from deviating in a non-height direction, thereby ensuring the positioning accuracy of the banknote-receiving bucket 30 and the accuracy of the position of the banknote-receiving bucket 30 during banknote receiving, so as to reduce the problems of the banknote receiving scattered, banknote falling, and etc.

After the banknote-receiving bucket 30 finishes banknote-receiving, the conveying unit 20 transports the banknote-receiving bucket 30 to the lifting unit 10 for output, and the jacking mechanism 41 may be reset.

Optionally, the second positioning groove 520 may be a blind hole.

The support board 50 may also have a connector 503, wherein the connection hole of the connector 503 faces to the second positioning groove 520. In other words, the connection hole of the connector 503 and the second positioning groove 520 are aligned along the same axis.

The limiting mechanism 42 further includes a plug 424, wherein a power input end of the plug 424 of the limiting mechanism 42 is electrically connected with the second positioning protrusion 423. When in use, the second positioning protrusion 423 can pass through the second positioning groove 520 to be conductively connected with the connection hole of the connector 503, so that the connector 503 and the plug 424 of the limiting mechanism 42 form a current circuit. At this time, an electrical signal is generated to determine that the limiting top plate 421 of the limiting mechanism 42 and the support board 50 are assembled in place.

Further, the plug 424 of the limiting mechanism 42 may also be communicatively connected with a controller, wherein the connector 503 located on the support board 50 may carry identity information, such as a serial number and etc., of the banknote-receiving bucket 30. After the plug 424 of the limiting mechanism 42 is connected with the connector 503, the controller may read the information carried by the connector 503, and then determine whether the banknote-receiving bucket 30 currently connected with the support board 50 of the limiting mechanism 42 is the selected banknote-receiving bucket 30 as well as possibly further determine whether the limiting top plate 421 of the limiting mechanism 42 and the support board 50 have completed positioning and assembling.

Further, the jacking mechanism 41 comprises a jacking assembly 411, a jacking motor 412, and a jacking detector 413, wherein the jacking motor 412 is communicatively connected with the jacking detector 413, and when the support board 50 is transported to a predetermined position, the jacking detector 413 obtains a signal, and the jacking motor 412 jacks up and lifts at least part of the jacking assembly 411 based on the signal obtained by the jacking detector 413, so as to jack up and lift the limiting top plate 421 of the limiting mechanism 42.

The jacking assembly 411 comprises a jacking bottom plate 4111, a jacking connecting shaft 4112, and a jacking top plate 4113, wherein the jacking top plate 4113 is located above the jacking bottom plate 4111, and the jacking connecting shaft 4112 is respectively connected with the jacking bottom plate 4111 and the jacking top plate 4113. The jacking bottom plate 4111 is affixedly mounted on the conveying frame 24 of the conveying unit 20.

The jacking top plate 4113 is mounted to the jacking connecting shaft 4112 in a back-and-forth shiftable manner relative to the jacking bottom plate 4111.

The jacking connecting shaft 4112 has a first connecting end and a second connecting end, wherein the first connecting end of the jacking connecting shaft 4112 is connected with the jacking top plate 4113, and the second connecting end of the jacking connecting shaft 4112 is connected with the jacking bottom plate 4111.

When the jacking top plate 4113 is jacked up, it may be by means of extending the portion of the first connecting end of the jacking connecting shaft 4112, or extending the portion of the second connecting end of the jacking connecting shaft 4112.

Specifically, the jacking assembly 411 further comprises a jacking connecting rod 4114, a jacking supporting member 4115, and a jacking rotating member 4116, wherein the jacking supporting member 4115 is arranged on the jacking connecting rod 4114, and the jacking connecting rod 4114 is rotatably connected with the jacking motor 412 in a drivable manner. The jacking rotating member 4116 is connected with the jacking top plate 4113 and can be supported by the jacking supporting member 4115.

When the jacking top plate 4113 needs to be jacked up, the jacking motor 412 drives the jacking connecting rod 4114 to rotate, so that the jacking supporting member 4115 connected with the jacking connecting rod 4114 and located below the jacking top plate 4113 rotate correspondingly, wherein the jacking supporting member 4115 has a supporting surface 41151, wherein the heights of the supporting surface 41151 at different positions are different. When the jacking supporting member 4115 rotates, the contact positions of the jacking supporting member 4115 and the jacking rotating member 4116 are different, so that the jacking rotating member 4116 can be jacked up.

The jacking rotating member 4116 is rotatably connected with the jacking top plate 4113, wherein when the jacking supporting member 4115 rotates along with the jacking connecting rod 4114, the jacking rotating member 4116 can rotate, so that the joint position of the jacking rotating member 4116 and the jacking supporting member 4115 is affixed relative to the jacking bottom plate 4111, thereby facilitating the stability of the entire jacking mechanism 41.

Optionally, the supporting surface 41151 may form a certain radian, such as being a concave supporting surface 41151 and etc., so that the jacking rotating member 4116 can be stably supported on the jacking supporting member 4115.

The jacking detector 413 may be configured to detect or determine when the jacking mechanism 41 needs to be jacked up and lifted, whether the jacking mechanism 41 is in place, and when jacking and repositioning needs to be performed.

For example, the jacking detector 413 may be mounted on the jacking top plate 4113, and when the jacking motor 412 drives to lift the jacking top plate 4113 to a certain height, the jacking detector 413 sends a signal to the jacking motor 412 to stop the operation of the jacking motor 412.

It should be noted that the jacking mechanisms 41 may be linked. When a plurality of the banknote-receiving buckets 30 are provided on the conveying unit 20, and all the banknote-receiving buckets 30 are blocked by the corresponding blocking mechanisms 43 respectively, the jacking mechanism 41 jacks up the limiting top plates 421 of the corresponding limiting mechanisms 42 at the same time.

Specifically, the jacking connecting rod 4114 of the jacking assembly 411 of the jacking mechanism 41 may be connected with the jacking supporting members 4115 of a plurality of the jacking assemblies 411, so that when the jacking connecting rod 4114 is driven to rotate, the plurality of jacking top plates 4113 can be lifted at the same time.

After the banknote-receiving bucket 30 is positioned at a preset position of the conveying unit 20 under the action of the jacking mechanism 41, the jacking mechanism 41 will be repositioned and the limiting top plate 421 of the limiting mechanism 42 affixedly connected with the jacking top plate 4113 of the jacking mechanism 41 will move down, so that the banknote-receiving bucket 30 can continue to be transported along the conveying channel 200.

According to the preferred embodiment, the conveying unit 20 includes two conveying channels 200, and the two conveying channels 200 communicate with each other through the lifting unit 10.

Specifically, the banknote-receiving bucket 30 of the conveying channel 200 located above is conveyed to the lifting unit 10, and then the lifting unit 10 transports the banknote-receiving bucket 30 to the conveying channel 200 located below, wherein the banknote-receiving bucket 30 of the conveying channel 200 located below is transported to the other lifting unit 10, and then the lifting unit 10 transports the banknote-receiving bucket 30 to the other conveying channel 200 located above.

Of course, the lifting unit 10 may also output the banknote-receiving bucket 30 to other positions. Here are merely examples and are not intended to limit the present invention.

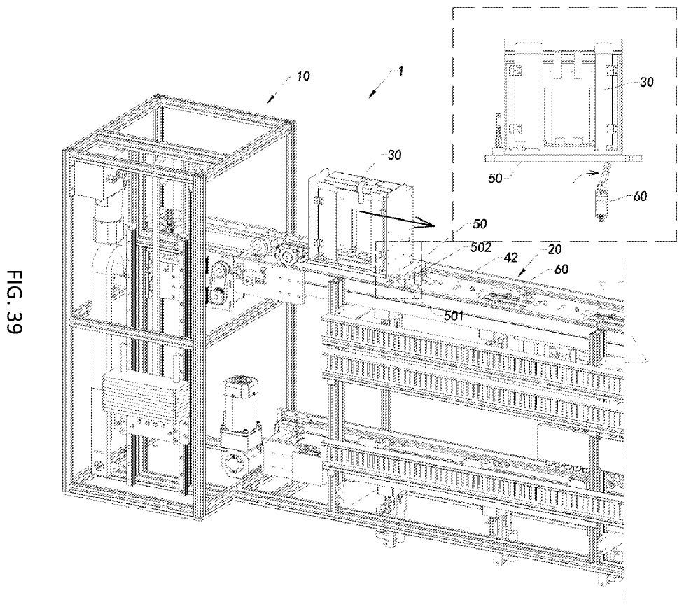

Referring to FIGS. 37A and 37B, the lifting unit 10 comprises a platform 11, a lifting rail 12, a lifting motor 13, and a lifting frame 14, wherein the lifting rail 12 and the lifting motor 13 are respectively mounted on the lifting frame 14 and the platform 11 is movably mounted on the lifting rail 12. The lifting rail 12 is drivably connected with the lifting motor 13 in a movable manner.

When the lifting track 12 is driven by the lifting motor 13 to move, the platform 11 connected with the lifting track 12 may also follow the lifting track 12 to move up and down.

The platform 11 has a track 110 arranged thereon, wherein the track 110 of the platform 11 can be aligned with the conveying channel 200 of the conveying unit 20, such that the banknote-receiving bucket 30 located on the conveyance unit 20 can be directly transported to the track 110 of the platform 11. The support board 50 is connected with the banknote-receiving bucket 30, and the support board 50 and the banknote-receiving bucket 30 are transported to the track 110 of the platform together during transportation.

When the banknote-receiving bucket 30 needs to be transported from the platform 11 towards other positions, the track 110 may be driven to move so as to transport the banknote-receiving bucket 30 and the support board 50 located on the track 110 outward to, for example, another conveying channel 200.

The lifting unit 10 further comprises a lifting sensor 15, wherein the lifting sensor 14 is mounted on the lifting frame 15, and the lifting sensor 15 can be utilized for detecting the height of the platform 11 to determine whether the platform 11 and the conveying channel 200 are in the same horizontal position, so as to determine whether the banknote-receiving bucket 30 can be transported between the lifting unit 10 and the conveying unit 20 in a subsequent step.

According to another aspect of the present invention, the present invention provides a conveying method of a banknote-receiving bucket, comprising the steps of:

conveying the banknote-receiving bucket 30 along the conveying channel 200; and

blocking the banknote-receiving bucket 30 in a predetermined position through extending the blocking mechanism 43 from the conveying channel 200.

According to the embodiments of the present invention, the banknote-receiving bucket 30 is limited to a fixed position after the banknote-receiving bucket 30 is blocked.

According to the embodiments of the present invention, the banknote-receiving bucket is limited through lifting the limiting top plate 421 to be assembled with the support board 50.

According to the embodiments of the present invention, the position of the support board 50 is determined through the stroke switch 60.

According to the embodiments of the present invention, the method further includes the following steps: outputting the banknote-receiving bucket 30 from the end of the conveying channel 200 through the lifting unit 10. After the banknote-receiving bucket 30 finishes banknote-receiving, the limiting top plate 421 is lowered, so that the blocking top plate 421 is lowered, thereby allowing the banknote-receiving bucket 30 continue to be transported.

According to the embodiments of the present invention, the conveying method further includes a step of: inputting the banknote-receiving bucket 30 from an end of the conveying channel 200 through the lifting unit 10. One skilled in the art will understand that the embodiment of the present invention as shown in the drawings and described above is exemplary only and not intended to be limiting. It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

1. A banknote-receiving bucket circulating conveying line apparatus, comprising:
at least one banknote-receiving bucket;
at least two lifting modules; and
a conveying module installed between said at least two lifting modules, wherein each of said at least two lifting modules is arranged for driving said banknote-receiving bucket to ascend and descend, so as to input or output said banknote-receiving bucket, wherein said conveying module comprises at least one conveying line, arranged for positioning and conveying said banknote-receiving bucket, so as to allow said banknote-receiving bucket to receive banknotes and convey banknotes to said lifting module to be output along said conveying line.

2. The banknote-receiving bucket circulating conveying line apparatus, as recited in claim 1, further comprising a tooling plate, wherein the banknote-receiving bucket, which is mounted on said tooling plate, comprises a first buffer block and a second buffer block respectively arranged on two parallel sides of said tooling plate, wherein said first buffer block and said second buffer block are resilient, wherein said tooling plate further has a first positioning hole and a second positioning hole, wherein a connector is affixed on said tooling plate and said second positioning hole is aligned with a connection hole of said connector.

3. The banknote-receiving bucket circulating conveying line apparatus, as recited in claim 2, wherein said lifting module comprises an elevator frame, wherein a lifting sliding rail is affixed on said elevator frame, wherein said lifting sliding rail is slidably assembled with a lifting sliding block and a heavy pressing sliding block,
wherein said heavy pressing sliding block is affixed on a heavy pressing supporting plate, wherein said heavy pressing supporting plate has a heavy pressing plate mounted thereon, wherein said lifting sliding block is affixed on one of two lifting side plates,
wherein said lifting side plate with said lifting sliding block mounted thereon is further assembled and affixed with an end of a lifting belt, wherein the other end of said lifting belt bypasses a lifting wheel to be assembled and affixed with said heavy pressing supporting plate, wherein said lifting wheel is affixed on a second lifting output shaft, wherein said second lifting output shaft is mounted in a second lifting motor.

4. The banknote-receiving bucket circulating conveying line apparatus, as recited in claim, wherein said conveying module comprises at least one conveying line and a conveying frame, wherein said conveying frame comprises a conveying bottom plate, a conveying side plate and a conveying supporting plate, arranged for assembling and affixing said conveying bottom plate and said conveying side plate, so as to form said conveying frame to provide support for said conveying line.

5. The banknote-receiving bucket circulating conveying line apparatus, as recited in claim 4, wherein said conveying line comprises a jacking mechanism, a positioning mechanism, a blocking device, a conveying motor, a stroke switch, and a conveying chain,
wherein each of said blocking device corresponds to one stroke switch, wherein both said blocking device and said stroke switch are mounted on a support board, wherein said support board is affixed on at least one of said conveying supporting plate and said conveying side plate, so as to form a pair of positioning blocking modules,
wherein said conveying side plate has a conveying guide groove and a conveying slot arranged thereon, wherein said conveying chain is mounted in said conveying slot,
wherein at least two said conveying side plates are provided, wherein one end of said two conveying side plates is rotatably assembled with a first conveying shaft respectively, while the other end of said conveying side plates is rotatably assembled with a second conveying shaft respectively,
wherein said first conveying shaft and said second conveying shaft respectively comprise a first conveying chain wheel and a second conveying chain wheel, wherein said first conveying chain wheel and said second conveying chain wheel are connected through said conveying chain to form a chain transmission mechanism,
wherein said first conveying shaft and the conveying output shaft of said conveying motor are assembled through a coupler, wherein said conveying chain comprises a plurality of conveying rotating wheels arranged thereon, wherein the top of said conveying rotating wheel penetrates out of said conveying slot and enters said conveying guide groove, wherein said conveying guide groove is adapted for being buckled and slidably assembled with said tooling plate, wherein said conveying rotating wheels are tightly attached to said tooling plate.

6. The banknote-receiving bucket circulating conveying line apparatus, as recited in claim 5, wherein said blocking device comprises a first blocking plate, a second blocking plate, a blocking affixing block, and a blocking wheel, wherein said first blocking plate and said second blocking plate are respectively affixed on said blocking affixing block, wherein said blocking affixing block is assembled and affixed with said conveying side plate, wherein a push rod motor is provided and mounted between said first blocking plate and said second blocking plate,
wherein said telescopic shaft of said push rod motor is mounted into a blocking connection barrel with a first blocking pin penetrating said blocking connection barrel and said telescopic shaft, so as to axially assemble and affix said blocking connection barrel and said telescopic shaft,
wherein said blocking connection barrel is arranged at an end of a blocking telescopic barrel, wherein said blocking telescopic barrel comprises a blocking telescopic inner barrel and a blocking mounting head arranged on the other end thereof,
wherein a second blocking pin penetrates a blocking mounting head and a blocking corner block, so as to hinge said blocking mounting head and said blocking corner block through said second blocking pin, wherein a mounting opening groove is disposed on said blocking corner block and a torsion spring is sleeved on the portion of said second blocking pin located in said mounting opening groove, wherein said blocking wheel is circumferentially rotatably mounted on a third blocking pin, and said third blocking pin is mounted on said blocking corner block.

7. The banknote-receiving bucket circulating conveying line apparatus, as recited in claim 5, wherein said stroke switch comprises a sensing part, wherein said sensing part is assembled with a stroke mounting block through a stroke shaft, and said stroke shaft is axially rotatable, wherein a stroke connecting plate is affixed on said stroke mounting block and a stroke rotating wheel is circumferentially rotatably mounted on said stroke connecting plate,
wherein in the initial state, said stroke connecting plate and the sensing portion form an included angle, wherein when said second buffer block drives said stroke connecting plate to rotate with said stroke shaft as the center, wherein said tooling plate is determined to reach the positioning position when said stroke connecting plate is perpendicular to said sensing part, wherein when said stroke switch outputs a signal for the second time, said tooling plate is determined as passing, wherein said tooling plate is repositioned after passing, wherein when the second signal output breaks, said tooling plate is determined as passed.

8. The banknote-receiving bucket circulating conveying line apparatus, as recited in claim 5, wherein said positioning mechanism comprises a positioning top plate, wherein said positioning top plate has a first positioning protruding shaft and a second positioning protruding shaft arranged thereon, wherein said positioning top plate is affixed on a jacking beam,
wherein after jacking said positioning top plate, said first positioning protruding shaft and said second positioning protruding shaft are respectively placed into said first positioning hole and said second positioning hole,
wherein said second positioning hole is a blind hole, wherein said positioning top plate has a plug, communicatively connected with a controller, wherein said connector has a serial number information of said banknote-receiving bucket, so that after said connector is plugged and connected with said plug, said controller reads the information carried in said connector to determine whether said banknote-receiving bucket is a selected banknote-receiving bucket, and to determine that said positioning top plate and said tooling plate have completed positioning and assembling.

9. The banknote-receiving bucket circulating conveying line apparatus, as recited in claim 5, wherein said jacking mechanism comprises at least two jacking assemblies and a jacking motor, wherein said jacking assembly comprises a first jacking affixing plate, a second jacking affixing plate, and a third jacking affixing plate, wherein said first jacking affixing plate and said third jacking affixing plate are connected and affixed through a jacking connecting shaft, and said first jacking affixing plate is mounted on said conveying side plate,
wherein said second jacking affixing plate is assembled and affixed with an end of a jacking guide shaft and said jacking beam, wherein the other end of said jacking guide shaft penetrates said third jacking affixing plate to be assembled and affixed with a jacking limiting plate, wherein said jacking limiting plate is prevented from passing through said third jacking affixing plate, and said jacking guide shaft and said third jacking affixing plate are axially movably assembled,
wherein said second jacking affixing plate has a jacking lug plate affixed thereon, wherein said jacking lug plate is assembled with a bearing shaft, wherein said bearing shaft is assembled and affixed with the inner ring of a bearing, wherein said third jacking affixing plate has a shaft seat mounted thereon, wherein said shaft seat is rotatably assembled with a jacking shaft, wherein an eccentric wheel is mounted on said jacking shaft at the corresponding position to said bearing, wherein said jacking shaft is connected with a jacking output shaft of said jacking motor through said coupler,
wherein said eccentric wheel has a jacking groove arranged thereon, wherein when said jacking mechanism lifts said jacking beam to the highest position, said jacking groove and said bearing are coupled and assembled.

10. The banknote-receiving bucket circulating conveying line apparatus, as recited in claim 9, wherein said third jacking affixing plate has a rotation limiting plate mounted in the vicinity of said eccentric wheel, wherein said rotation limiting plate has a rotation positioning sensor mounted thereon, implemented as a pressure sensor, wherein when said eccentric wheel rotates to be coupled and assembled with said bearing, said eccentric wheel is pressed with said rotation positioning sensor, so that said rotation positioning sensor obtains a signal input for determining that the rotation is in place, and said jacking motor stops operating,
wherein said third jacking affixing plate also has a reposition sensor mounted thereon, wherein an iron sensing block is mounted on said first jacking affixing plate at a position corresponding to said reposition sensor,
wherein when said jacking mechanism is in a non-jacking state, said reposition sensor detects constant electrical signal and the electric signal value is large, so as to determine an initial state,
wherein when said reposition sensor detects gradually weaker electrical signal, a jacking period is determined,
wherein when said reposition sensor detects a constant electrical signal and the electrical signal value is small, a jacking state is determined,
wherein when said jacking mechanism has jacked and needs to be repositioned, said jacking motor rotates reversely until said reposition sensor detects the electric signal of the initial state to stop said jacking motor from operating.

11. A banknote-receiving bucket conveying apparatus, adapted for conveying at least a banknote-receiving bucket, comprising:
a conveying unit, wherein said conveying unit has a conveying channel to allow the banknote-receiving bucket to be convey along said conveying channel; and
a positioning unit, arranged on said conveying unit, wherein said positioning unit is arranged to position if the banknote-receiving bucket is at a preset position of said conveying unit.

12. The banknote-receiving bucket conveying apparatus, as recited in claim 11, further comprising a lifting unit, wherein said lifting unit is disposed at an end of said conveying unit, allowing the banknote-receiving bucket to be automatically conveyed to said lifting unit along said conveying channel, wherein said lifting unit is configured to drive the banknote-receiving bucket to ascend and descend.

13. The banknote-receiving bucket conveying apparatus, as recited in claim 12, wherein said positioning unit comprises a blocking mechanism, wherein said blocking mechanism is located in said conveying channel is at least partly higher than a support board utilized in supporting the banknote-receiving bucket, so as to block the banknote-receiving bucket at a preset position.

14. The banknote-receiving bucket conveying apparatus, as recited in claim 13, further comprising a stroke switch, wherein said stroke switch is disposed on said conveying unit and located in said conveying channel, wherein said stroke switch is configured to detect a stroke and a position of the banknote-receiving bucket.

15. The banknote-receiving bucket conveying apparatus, as recited in claim 12, wherein said positioning unit comprises a jacking mechanism and a limiting top plate, wherein said limiting top plate is liftable to be connected with said jacking mechanism, wherein when the banknote-receiving bucket is located above said limiting top plate, said limiting top plate is allowed to be lifted to be assembled with a support board for supporting the banknote-receiving bucket.

16. The banknote-receiving bucket conveying apparatus, as recited in claim 15, wherein said jacking top plate has a first positioning protrusion and a second positioning protrusion, wherein said support board has a first positioning groove and a second positioning groove, wherein when said limiting top plate is lifted to be assembled with said support board, said first positioning protrusion is coupled with said first positioning groove, and said second positioning protrusion is coupled with said second positioning groove to position the banknote-receiving bucket.

17. The banknote-receiving bucket conveying apparatus, as recited in claim 15, wherein said jacking top plate has a plug arranged thereon, wherein said support board has a connector, wherein when said jacking top plate is assembled with said support board, said plug is conducted with said connector.

18. The banknote-receiving bucket conveying apparatus, as recited in claim 13, wherein said blocking mechanism comprises a blocking motor, a blocking telescopic assembly, and a blocking member, wherein said blocking member is supported on said blocking telescopic assembly, wherein said blocking telescopic assembly is drivably connected with said blocking motor, wherein when the banknote-receiving bucket blocked by said blocking member completes banknote-receiving, said blocking motor drives said blocking telescopic assembly to retract, so that said blocking member moves downwards to be not higher than said support board, so as to allow the banknote-receiving bucket to continue to be conveyed forwards.

19. The banknote-receiving bucket conveying apparatus, as recited in claim 15, wherein said support board has a first buffer block, wherein said first buffer block is located on a side of said support board, and when said support board is blocked by said blocking mechanism, said first buffer block is located between said support board while said blocking mechanism providing a cushioning effect.

20. A conveying method of a banknote-receiving bucket, comprising steps of:
conveying the banknote-receiving bucket along a conveying channel; and
blocking the banknote-receiving bucket from a preset position by means of a blocking mechanism extending from said conveying channel.

21. The conveying method, as recited in claim 20, wherein said blocking mechanism comprises a blocking motor, a blocking telescopic assembly, and a blocking member, wherein said blocking member is supported on said blocking telescopic assembly, wherein said blocking telescopic assembly is drivably connected with said blocking motor, wherein when the banknote-receiving bucket blocked by said blocking member completes banknote-receiving, said blocking motor drives said blocking telescopic assembly to retract, so that said blocking member moves downwards to be not higher than a support board utilized in supporting the banknote-receiving bucket, so as to allow the banknote-receiving bucket to continue to be conveyed forwards.

22. The conveying method, as recited in claim 21, wherein said support board has a first buffer block, wherein said first buffer block is located on a side of said support board, and when said support board is blocked by said blocking mechanism, said first buffer block is located between said support board while said blocking mechanism providing a cushioning effect.
